(19) United States
(12) Patent Application Publication
(10) Pub. No.: US 2012/0134598 A1
(43) Pub. Date: May 31, 2012

(54) Depth Sensor, Method Of Reducing Noise In The Same, And Signal Processing System Including The Same

(75) Inventors: Ilia Ovsiannikov, Studio City, CA (US); Dong Ki Min, Seoul (KR); Young Gu Jin, Osan-si (KR)

(73) Assignee: SAMSUNG ELECTRONICS CO., LTD., Suwon-si (KR)

(21) Appl. No.: 13/297,797

(22) Filed: Nov. 16, 2011

(30) Foreign Application Priority Data
Nov. 26, 2010 (KR) 10-2010-0118859

(51) Int. Cl. G06K 9/64

(52) U.S. Cl. 382/217

(57) ABSTRACT

The method includes calculating similarities between a plurality of pixel signals of a depth pixel and a plurality of pixel signals of neighbor depth pixels neighboring the depth pixel, calculating a weight of each of the neighbor depth pixels using the similarities, calculating a weight of the depth pixel using the weights of the respective neighbor depth pixels, and determining a denoised pixel signal using the weights of the respective neighbor depth pixels and the weight of the depth pixel.

### CROSS-REFERENCE TO RELATED APPLICATIONS

This application claims priority under 35 U.S.C. §119 to the benefit of Korean Patent Application No. 10-2010-0118859, filed on Nov. 26, 2010, in the Korean Intellectual Property Office, the entire disclosure of which is incorporated herein by reference.

### BACKGROUND

Example embodiments relate to a depth sensor using a time-of-flight (TOF) principle, and more particularly, to a depth sensor for reducing pixel signal noise, a method thereof, and/or a signal processing system including the depth sensor.

Depth images are obtained with a depth sensor using the TOF principle. The depth images may include noise. Accordingly, a method of reducing pixel noise by detecting and correcting defective pixels is desired.

### SUMMARY

Some embodiments provide a depth sensor for reducing pixel noise by detecting and correcting defective pixels, a method of reducing noise in the same, and/or a signal processing system including the same.

According to some embodiments, there is provided a method of reducing noise in a depth sensor. The method includes the operations of calculating similarities between a plurality of pixel signals of a depth pixel and a plurality of pixel signals of neighbor depth pixels neighboring the depth pixel, calculating a weight of each of the neighbor depth pixels using the similarities, calculating a weight of the depth pixel using the weights of the respective neighbor depth pixels, and determining a denoised pixel signal using the weights of the respective neighbor depth pixels and the weight of the depth pixel.

The similarities may include a first similarity between a first depth differential pixel signal of the depth pixel and a first neighbor differential pixel signal of each of the neighbor depth pixels. The first differential pixel signal of the depth pixel is a difference between a first pair of the plurality of pixel signals of the depth pixel. The first neighbor differential pixel signal of each of the neighbor depth pixels is a difference between a first pair of the plurality of pixel signals of the neighbor depth pixel. The similarities may also include a second similarity between a second depth differential pixel signal of the depth pixel and a second neighbor differential pixel signal of each of the neighbor depth pixels. The second differential pixel signal of the depth pixel is a difference between a second pair of the plurality of pixel signals of the depth pixel, and the second neighbor differential pixel signal of each of the neighbor depth pixels is a difference between a second pair of the plurality of pixel signals of the neighbor depth pixel. The similarities may also include a third similarity between an amplitude of the depth pixel and an amplitude of each of the neighbor depth pixels, and a fourth similarity between an offset of the depth pixel and an offset of each of the neighbor depth pixels. The offset of the depth pixel is based on the differences between the first and second pairs of the plurality of pixel signals of the depth pixel, and the offset of each of the neighbor depth pixels is based on the differences between the first and second pairs of the neighbor depth pixel.

In one embodiment of the method, the plurality of pixel signals of the depth pixel and each of the neighbor depth pixels respectively includes first, second, third and fourth pixel signals. The method may further include the operations of calculating each of the first differential pixel signals by subtracting the second pixel signal from the fourth pixel signal respectively associated with the depth pixel and the neighbor depth pixels, calculating each of the second differential pixel signals by subtracting the first pixel signals from the third pixel signal respectively associated with the depth pixel and the neighbor depth pixels, calculating amplitudes of the depth pixel and the neighbor depth pixels based on the first through fourth pixel signals associated therewith.

The operation of calculating the weight of each of the neighbor depth pixels may include adding a product of the first similarity and a first weight coefficient, a product of the second similarity and a second weight coefficient, a product of the third similarity and a third weight coefficient, and a product of the fourth similarity and a fourth weight coefficient together.

Alternatively, the operation of calculating the weight of each of the neighbor depth pixels may include multiplying the first similarity to the power of a first weight coefficient of the first similarity, the second similarity to the power of a second weight coefficient of the second similarity, the third similarity to the power of a third weight coefficient of the third similarity, and the fourth similarity to the power of a fourth weight coefficient of the fourth similarity together.

The sum of the weight coefficients may be 1.

The operation of calculating the weight of the depth pixel may include subtracting weights of the respective neighbor depth pixels from a value obtained by adding one plus a number of the neighbor depth pixels.

The operation of calculating the denoised pixel signal may include dividing a first value by a second value. The first value may be obtained by adding a product of the first differential pixel signal of the depth pixel and the weight of the depth pixel to a sum of values obtained by respectively multiplying the first differential pixel signals of the respective neighbor depth pixels by the weights of the respective neighbor depth pixels. The second value may be obtained by adding one plus a number of the neighbor depth pixels.

The operation of calculating the denoised pixel signal may include dividing a first value by a second value. The first value, may be obtained by adding a product of the second differential pixel signal of the depth pixel and the weight of the depth pixel to a sum of values obtained by respectively multiplying the second differential pixel signals of the respective neighbor depth pixels by the weights of the respective neighbor depth pixels. The second value may be obtained by adding one plus a number of the neighbor depth pixels.

The denoised pixel signal may be a denoised first differential pixel signal or a denoised second differential pixel signal.

The method may further include the operation of generating one of an updated first differential pixel signal and an updated second differential pixel signal based on the denoised pixel signal.

The operation of generating one of the updated first and second differential pixel signals may be repeated.

In another embodiment, the method includes determining at least one similarity metric between output from a depth pixel and at least one neighbor depth pixel. The neighbor depth pixel neighbors the depth pixel. The method further includes determining a weight associated with the neighbor depth pixel based on the similarity metric, and filtering output from the depth pixel based on the determined weight.

According to another embodiment, there is provided a depth sensor including a light source configured to emit modulated light to a target object; a depth pixel and neighbor depth pixels neighboring the depth pixel. Each of the depth pixel and the neighbor depth pixels are configured to detect a plurality of pixel signals at different time points according to light reflected from the target object. A digital circuit is configured to convert the plurality of pixel signals into a plurality of digital pixel signals. A memory is configured to store the plurality of digital pixel signals. A noise reduction filter is configured to calculate similarities between a plurality of digital pixel signals of the depth pixel and a plurality of digital pixel signals of the neighbor depth pixels, calculate a weight of each of the neighbor depth pixels using the similarities, calculate a weight of the depth pixel using the weights of the respective neighbor depth pixels, and determine a denoised pixel signal using the weights of the respective neighbor depth pixels and the weight of the depth pixel.

The similarities may include a first similarity between a first depth differential digital pixel signal of the depth pixel and a first neighbor differential digital pixel signal of each of the neighbor depth pixels. The first differential pixel signal of the depth pixel is a difference between a first pair of the plurality of pixel signals of the depth pixel. The first neighbor differential pixel signal of each of the neighbor depth pixels is a difference between a first pair of the plurality of pixel signals of the neighbor depth pixel. The similarities may also include a second similarity between a second depth differential digital pixel signal of the depth pixel and a second neighbor differential digital pixel signal of each of the neighbor depth pixels. The second differential pixel signal of the depth pixel is a difference between a second pair of the plurality of pixel signals of the depth pixel, and the second neighbor differential pixel signal of each of the neighbor depth pixels is a difference between a second pair of the plurality of pixel signals of the neighbor depth pixel. The similarities may also include a third similarity between an amplitude of the depth pixel and an amplitude of each of the neighbor depth pixels, and a fourth similarity between an offset of the depth pixel and an offset of each of the neighbor depth pixels. The offset of the depth pixel is based on the differences between the first and second pairs of the plurality of pixel signals of the depth pixel, and the offset of each of the neighbor depth pixels is based on the differences between the first and second pairs of the neighbor depth pixel.

The noise reduction filter is configured to calculate the weight of the depth pixel by subtracting weights of the respective neighbor depth pixels from a value obtained by adding one plus the number of the neighbor depth pixels.

### BRIEF DESCRIPTION OF THE DRAWINGS

The above and other features and advantages of the embodiments will become more apparent by describing in detail exemplary embodiments thereof with reference to the attached drawings in which:

FIG. 1 is a block diagram of a depth sensor according to an example embodiment;

FIG. 2 is a plan view of a 2-tap depth pixel included in an array illustrated in FIG. 1,

FIG. 3 is a cross-sectional view of the 2-tap depth pixel illustrated in FIG. 2, taken along the line III-III′;

FIG. 4 is a timing chart of photo gate control signals for controlling photo gates included in the 2-tap depth pixel illustrated in FIG. 1;

FIG. 5 is a timing chart for explaining a plurality of pixel signals sequentially detected using the 2-tap depth pixel illustrated in FIG. 1;

FIG. 6 is a block diagram of a plurality of pixels illustrated in FIG. 1;

FIGS. 7A through 7D are diagrams each showing digital pixel signals of respective pixels illustrated in FIG. 6;

FIG. 8 is a diagram showing a first differential pixel signal of each of the pixels illustrated in FIG. 6;

FIG. 9 is a diagram showing first similarity of each of neighbor depth pixels illustrated in FIG. 6;

FIG. 10 is a diagram showing a second differential pixel signal of each of the pixels illustrated in FIG. 6;

FIG. 11 is a diagram showing second similarity of each of the neighbor depth pixels illustrated in FIG. 6;

FIG. 12 is a diagram showing an amplitude of each of the pixels illustrated in FIG. 6;

FIG. 13 is a diagram showing third similarity of each of the neighbor depth pixels illustrated in FIG. 6;

FIG. 14 is a diagram showing an offset of each of the pixels illustrated in FIG. 6;

FIG. 15 is a diagram showing fourth similarity of each of the neighbor depth pixels illustrated in FIG. 6;

FIG. 16 is a diagram showing a weight of each of the neighbor depth pixels illustrated in FIG. 6;

FIG. 17 is a diagram showing a weight of a depth pixel illustrated in FIG. 6;

FIGS. 18A and 18B are diagrams showing denoised pixel signals of the depth pixel illustrated in FIG. 6;

FIG. 19 is a flowchart of a method of reducing noise of a depth sensor according to an example embodiment;

FIG. 20 is a diagram of a unit pixel array of a three-dimensional (3D) image sensor according to an example embodiments;

FIG. 21 is a diagram of a unit pixel array of a 3D image sensor according to another example embodiment;

FIG. 22 is a block diagram of a 3D image sensor according to an example embodiment;

FIG. 23 is a block diagram of an image processing system including the 3D image sensor illustrated in FIG. 22;

FIG. 24 is a block diagram of an image processing system including a color image sensor and the depth sensor illustrated in FIG. 1; and

FIG. 25 is a block diagram of a signal processing system including the depth sensor illustrated in FIG. 1.

### DETAILED DESCRIPTION OF THE EMBODIMENTS

Example embodiments now will be described more fully hereinafter with reference to the accompanying drawings, in which embodiments are shown. The embodiments may, however, be embodied in many different forms and should not be construed as limited to those set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

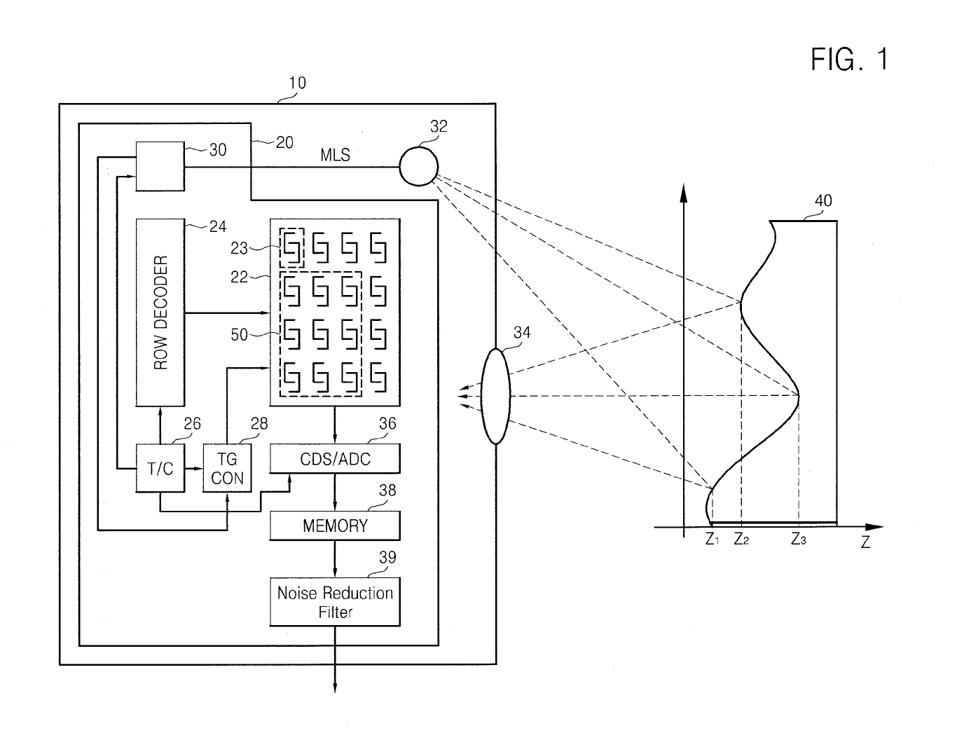

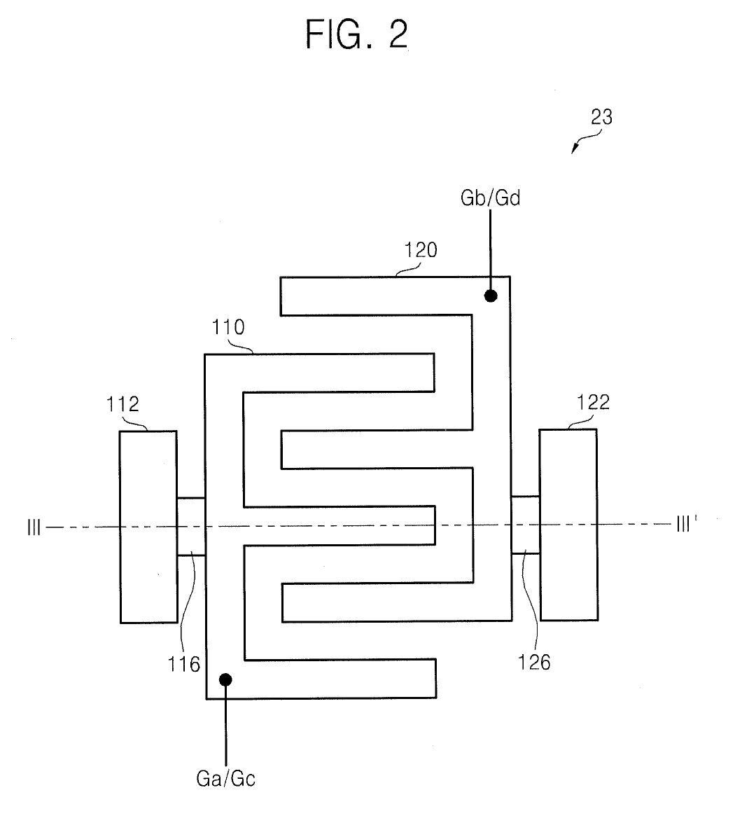

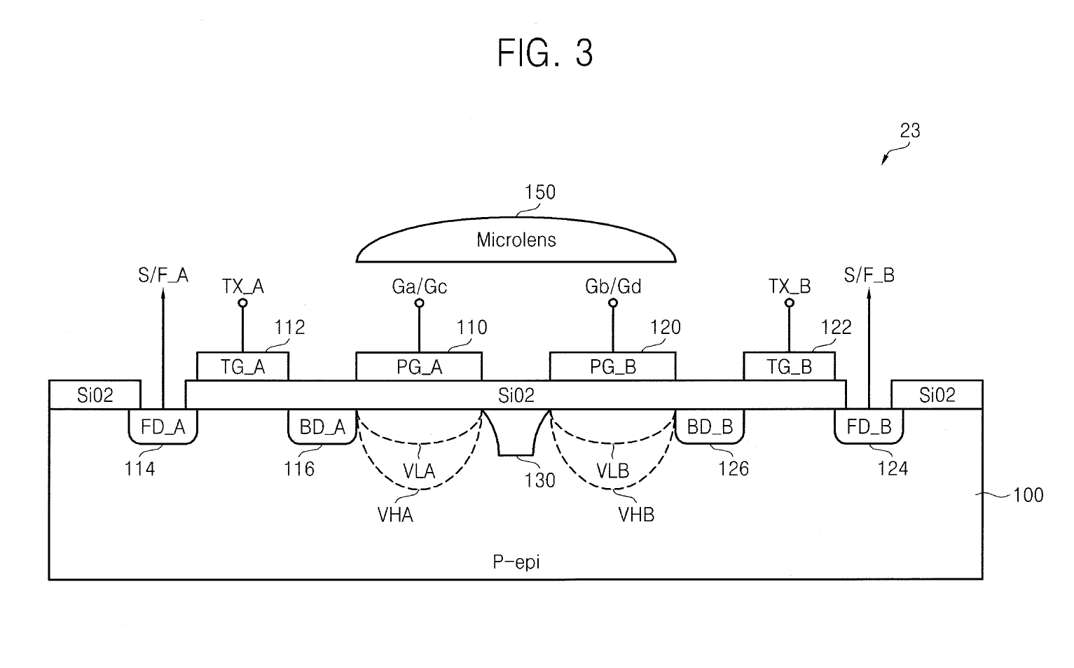

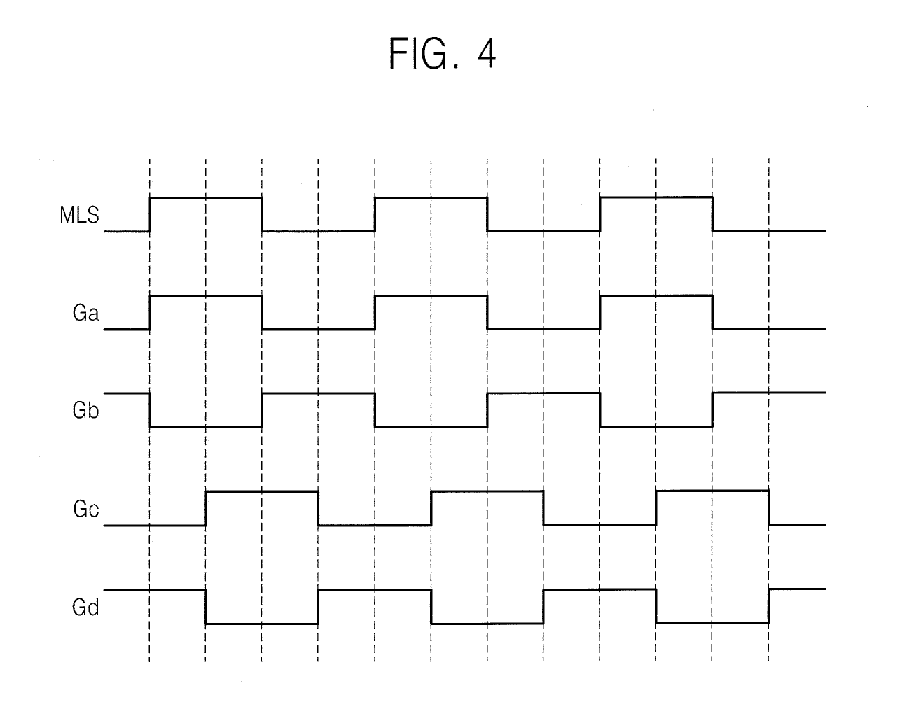

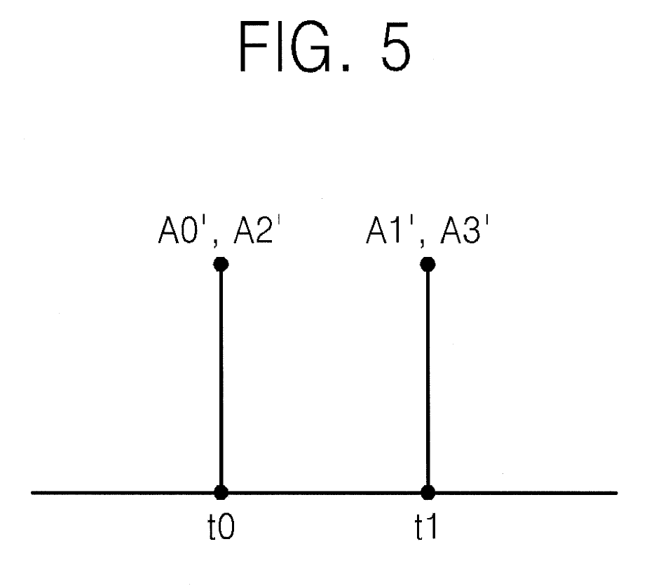

FIG. 1 is a block diagram of a depth sensor 10 according to an example embodiment. FIG. 2 is a plan view of a 2-tap depth pixel 23 included in an array 22 illustrated in FIG. 1. FIG. 3 is a cross-sectional view of the 2-tap depth pixel 23 illustrated in FIG. 2, taken along the line III-III′. FIG. 4 is a timing chart of photo gate control signals for controlling photo gates 110 and 120 included in the 2-tap depth pixel 23 illustrated in FIG. 1. FIG. 5 is a timing chart for explaining a plurality of pixel signals sequentially detected using the 2-tap depth pixel 23 illustrated in FIG. 1.

Referring to FIGS. 1 through 5, the depth sensor 10 that can measure a distance or a depth using a time-of-flight (TOF) principle includes a semiconductor chip 20, which includes the array 22 in which a plurality of 2-tap depth pixels (detectors or sensors) 23 are arranged, a light source 32, and a lens module 34. The 2-tap depth pixels 23 may be replaced by 1-tap depth pixels.

Each of the 2-tap depth pixels 23 implemented in the array 22 in two dimensions includes a plurality of the photo gates 110 and 120 (see FIG. 2).

The photo gates 110 and 120 may be formed using transparent poly silicon. In other embodiments, the photo gates 110 and 120 may be formed using indium tin oxide (ITO or tin-doped indium oxide), indium zinc oxide (IZO), or zinc oxide (ZnO).

The photo gates 110 and 120 may transmit near infrared rays received through the lens module 34. Each 2-tap depth pixel 23 may also include a P-type substrate 100.

Referring to FIGS. 2 through 4, a first floating diffusion region 114 and a second floating diffusion region 124 are formed in the P-type substrate 100.

The first floating diffusion region 114 may be connected to a gate of a first drive transistor S/F_A (not shown) and the second floating diffusion region 124 may be connected to a gate of a second drive transistor S/F_B (not shown). Each of the drive transistors S/F_A and S/F_B may function as a source follower. The floating diffusion regions 114 and 124 may be doped with N-type dopant.

A silicon oxide layer is formed on the P-type substrate 100. The photo gates 110 and 120 and transfer transistors 112 and 122 are formed on the silicon oxide layer. An isolation region 130 may be formed in the P-type substrate 100 to prevent photocharges generated respectively by the photo gates 110 and 120 in the P-type substrate 100 from influencing to each other.

The P-type substrate 100 may be a P-doped epitaxial substrate and the isolation region 130 may be a P+ doped region. The isolation region 130 may be implemented using shallow trench isolation (STI) or local oxidation of silicon (LOCOS).

For a first integration time, a first photo gate control signal Ga is provided to the first photo gate 110 and a second photo gate control signal Gb is provided to the second photo gate 120 (see FIG. 5).

In addition, a first transfer control signal TX_A for transmitting photocharges generated in the P-type substrate 100 below the first photo gate 110 to the first floating diffusion region 114 is provided to a gate of the first transfer transistor 112. A second transfer control signal TX_B for transmitting photocharges generated in the P-type substrate 100 below the second photo gate 120 to the second floating diffusion region 124 is provided to a gate of the second transfer transistor 122.

A first bridging diffusion region 116 may also be formed in the P-type substrate 100 between a portion below the first photo gate 110 and a portion below the first transfer transistor 112 and a second bridging diffusion region 126 may also be formed in the P-type substrate 100 between a portion below the second photo gate 120 and a portion below the second transfer transistor 122. The first and second bridging diffusion regions 116 and 126 may be doped with N-type dopant.

Photocharges are generated by optical signals input to the P-type substrate 100 through the photo gates 110 and 120. The 2-tap depth pixel 23 illustrated in FIG. 3 includes a microlens 150 formed above the photo gates 110 and 120, but it may not include the microlens 150 in other embodiments.

When the first transfer control signal TX_A at a first level (e.g., 1.0 V) is provided to the gate of the first transfer transistor 112 and the first photo gate control signal Ga at a high level (e.g., 3.3 V) is provided to the first photo gate 110, charges generated in the P-type substrate 100 gather below the first photo gate 110, which is referred to as first charge collection. The collected charges are transferred to the first floating diffusion region 114 directly (for instance, when the first bridging diffusion region 116 is not formed) or through the first bridging diffusion region 116 (for instance, when the first bridging diffusion region 116 is formed), which is referred to as first charge transfer.

Simultaneously, when the second transfer control signal TX_B at a first level (e.g., 1.0 V) is provided to the gate of the second transfer transistor 122 and the second photo gate control signal Gb at a low level (e.g., 0 V) is provided to the second photo gate 120, photocharges are generated in the P-type substrate 100 below the second photo gate 120 but are not transferred to the second floating diffusion region 124.

In FIG. 3, VHA denotes a region where potentials or photocharges are accumulated when the first photo gate control signal Ga at the high level is provided to the first photo gate 110 and VLB denotes a region where potentials or photocharges are accumulated when the second photo gate control signal Gb at the low level is provided to the second photo gate 120.

When the first transfer control signal TX_A at the first level (e.g., 1.0 V) is provided to the gate of the first transfer transistor 112 and the first photo gate control signal Ga at the low level (e.g., 0 V) is provided to the first photo gate 110, photocharges are generated in the P-type substrate 100 below the first photo gate 110 but are not transferred to the first floating diffusion region 114.

Simultaneously, when the second transfer control signal TX_B at the first level (e.g., 1.0 V) is provided to the gate of the second transfer transistor 122 and the second photo gate control signal Gb at the high level (e.g., 3.3 V) is provided to the second photo gate 120, charges generated in the P-type substrate 100 gather below the second photo gate 120, which is referred to as second charge collection. The collected charges are transferred to the second floating diffusion region 124 directly (for instance, when the second bridging diffusion region 126 is not formed) or through the second bridging diffusion region 126 (for instance, when the second bridging diffusion region 126 is formed), which is referred to as second charge transfer.

In FIG. 3, VHB denotes a region where potentials or photocharges are accumulated when the second photo gate control signal Gb at the high level is provided to the second photo gate 120 and VLA denotes a region where potentials or photocharges are accumulated when the first photo gate control signal Ga at the low level is provided to the first photo gate 110.

Charge collection and charge transfer, which occur when a third photo gate control signal Gc is provided to the first photo gate 110, is similar to the first charge collection and the first charge transfer which occur when the first photo gate control signal Ga is provided to the first photo gate 110.

In addition, charge collection and charge transfer, which occur when a fourth photo gate control signal Gd is provided to the second photo gate 120, is similar to the second charge collection and the second charge transfer which occur when the second photo gate control signal Gb is provided to the second photo gate 120.

Referring to FIG. 1, a row decoder 24 selects one row from among a plurality of rows in response to a row address output from a timing controller 26. Here, a row is a set of 2-tap depth pixels arranged in a row direction in the array 22.

A photo gate controller 28 may generate a plurality of the photo gate control signals Ga, Gb, Gc, and Gd and provide them to the array 22 under the control of the timing controller 26.

As illustrated in FIG. 4, the difference between a phase of the first photo gate control signal Ga and a phase of the third photo gate control signal Gc is 90°. The difference between the phase of the first photo gate control signal Ga and a phase of the second photo gate control signal Gb is 180°. The difference between the phase of the first photo gate control signal Ga and a phase of the fourth photo gate control signal Gd is 270°.

A light source driver 30 may generate a clock signal MLS for driving a light source 32 under the control of the timing controller 26.

The light source 32 emits a modulated optical signal to a target object 40 in response to the clock signal MLS. A light emitting diode (LED), an organic light emitting diode (OLED), an active-matrix organic light emitting diode (AMOLED), or a laser diode may be used as the light source 32. For clarity of the description, it is assumed that the modulated optical signal is the same as the clock signal MLS. The modulated optical signal may be a sine wave or a square wave.

The light source driver 30 provides the clock signal MLS or information about the clock signal MLS to the photo gate controller 28. Accordingly, the photo gate controller 28 generates the first photo gate control signal Ga having the same phase as the clock signal MLS and the second photo gate control signal Gb having a 180° phase difference from the clock signal MLS. In addition, the photo gate controller 28 generates the third photo gate control signal Gc having a 90° phase difference from the clock signal MLS and the fourth photo gate control signal Gd having a 270° phase difference from the clock signal MLS. The photo gate controller 28 and the light source driver 30 may operate in synchronization with each other.

The modulated optical signal output from the light source 32 is reflected from the target object 40. A plurality of reflected optical signals are input to the array 22 through the lens module 34. Here, the lens module 34 may include a lens and an infrared pass filter. The depth sensor 10 includes a plurality of light sources arranged in circle around the lens module 34, but only one light source 32 is illustrated in FIG. 1 for clarity of the description.

The optical signals input to the array 22 through the lens module 34 may be demodulated by a plurality of sensors 23. In other words, the optical signals input to the array 22 through the lens module 34 may form an image.

Each of the 2-tap depth pixels 23 accumulates photoelectrons or photocharges for a desired (or, alternatively a predetermined) period of time, e.g., an integration time, in response to the photo gate control signals Ga through Gd and outputs pixel signals A0′ and A2′ and pixel signals A1′ and A3′, which are generated according to accumulation results, to the correlated double sampling (CDS)/analog-to-digital converting (ADC) circuit 36 via a first and second transfer transistors 112, 122 and the first and second floating diffusion regions 114, 124 respectively.

For instance, each 2-tap depth pixel 23 accumulates photoelectrons for a first integration time in response to the first photo gate control signal Ga and the second photo gate control signal Gb and outputs the first pixel signal A0′ and the third pixel signal A2′ generated according to accumulation results. In addition, the 2-tap depth pixel 23 accumulates photoelectrons for a second integration time in response to the third photo gate control signal Gc and the fourth photo gate control signal Gd and outputs the second pixel signal A1′ and the fourth pixel signal A3′ generated according to accumulation results.

A pixel signal Ak′ generated by the 2-tap depth pixel 23 is expressed by Equation 1:

$${A}_{k}^{′} = {\sum }_{n = 1}^{N} {a}_{k , n} \qquad ( 1 )$$

Here, when a signal input to the photo gate 110 or 120 of the 2-tap depth pixel 23 has a 0° phase difference from the clock signal MLS, k is 0. When the signal has a 90° phase difference from the clock signal MLS, k is 1. When the signal has a 180° phase difference from the clock signal MLS, k is 2. When the signal has a 270° phase difference from the clock signal MLS, k is 3.

“a_{k,n}” denotes the number of photoelectrons (or photocharges) generated in the 2-tap depth pixel 23 when an n-th gate signal is applied with a phase difference corresponding to “k” where “n” is a natural number and N=fm*Tint where “fm” is a frequency of the modulated optical signal and “Tint” is the integration time.

Referring to FIG. 5, each of the 2-tap depth pixels 23 detects the first pixel signal A0′ and the third pixel signal A2′ at a first time point t0 in response to the first photo gate control signal Ga and the second photo gate control signal Gb and detects the second pixel signal A1′ and the fourth pixel signal A3′ at a second time point t1 in response to the third photo gate control signal Gc and the fourth photo gate control signal Gd.

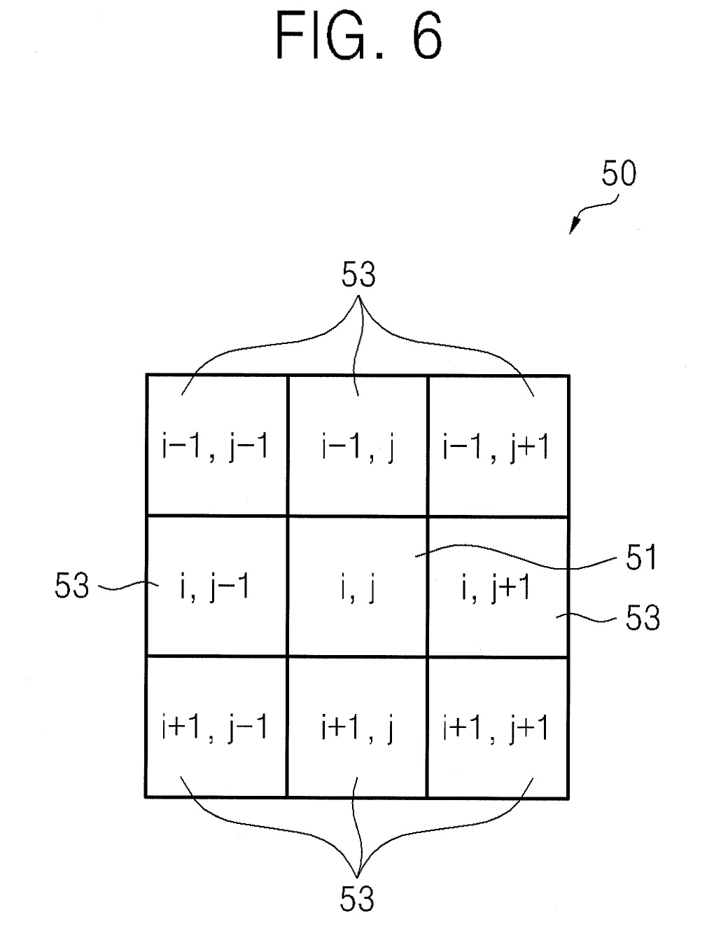

FIG. 6 is a block diagram of a pixel block 50 illustrated in FIG. 1. Referring to FIGS. 1 through 6, the pixel block 50 includes a depth pixel 51 and its neighbor depth pixels 53. The pixel block 50 serves as a filter mask defining the neighbor depth pixels 53 of the depth pixel. The filter mask is not limited to the shape or size shown in the figures.

The depth pixel 51 detects a plurality of depth pixel signals A0′(i,j), A1′(i,j), A2′(i,j), and A3′(i,j) in response to a plurality of the photo gate control signals Ga through Gd. The neighbor depth pixels 53 detect a plurality of neighbor depth pixel signals A0′(i−1,j−1), A1′(i−1,j−1), A2′(i−1,j−1), A3′(i−1,j−1), . . . , A0′(i+1,j+1), A1′(i+1,j+1), A2′(i+1,j+1), A3′(i+1,j+1) in response to the photo gate control signals Ga through Gd. Here, “i” and “j” are natural numbers and used to indicate the position of each pixel.

Referring to FIG. 1, under the control of the timing controller 26, a digital circuit, i.e., a correlated double sampling (CDS)/analog-to-digital converting (ADC) circuit 36 performs CDS and ADC on the pixel signals A0′, A2′, A1′, and A3′ output from the plurality of the 2-tap depth pixels 23 and outputs digital pixel signals A0, A1, A2, and A3.

For instance, the CDS/ADC circuit 36 performs CDS and ADC on the depth pixel signals A0′(i,j), A1′(i,j), A2′(i,j), and A3′(i,j) output from the depth pixel 51 and the neighbor depth pixel signals A0′(i−1,j−1), A1′(i−1,j−1), A2′(i−1,j−1), A3′(i−1,j−1), A0′(i+1,j+1), A1′(i+1,j+1), A2′(i+1,j+1), A3′(i+1,j+1) output from the neighbor depth pixels 53 and outputs digital depth pixel signals A0(i,j), A1(i,j), A2(i,j), and A3(i,j) and digital neighbor depth pixel signals A0(i−1,j−1), A1(i−1,j−1), A2(i−1,j−1), A3(i−1,j−1), . . . , A0(i+1,j+1), A1(i+1,j+1), A2(i+1,j+1), A3(i+1,j+1).

The digital pixel signals A0, A1, A2, and A3 are expressed by Equations 2 through 5:

A0≅α+β cos θ (2)

A2≅α−β cos θ (3)

A1≅α+β sin θ (4)

A3≅α−β sin θ (5)

where α indicates an amplitude and β indicates an offset. The offset is background intensity.

α and β are respectively expressed by Equations 6 and 7 using Equations 2 through 5.

$$\begin{matrix}α = ( A 0 + A 1 + A 2 + A 3 ) / 4. & ( 6 ) \\ β = \sqrt{\frac{{( A 3 - A 1 )}^{2} + {( A 2 - A 0 )}^{2}}{2}} & ( 7 )\end{matrix}$$

The depth sensor 10 illustrated in FIG. 1 may also include a plurality of active load circuits for transmitting-pixel signals output from a plurality of column lines in the array 22 to the CDS/ADC circuit 36.

A memory 38 may be implemented as a buffer. The memory 38 receives and stores the digital pixel signals A0, A1, A2, and A3 output from the CDS/ADC circuit 36. For instance, the memory 38 receives and stores the digital depth pixel signals A0(i,j), A1(i,j), A2(i,j), and A3(i,j) and the digital neighbor depth pixel signals A0(i−1,j−1), A1(i−1,j−1), A2(i−1,j−1), A3(i−1,j−1), . . . , A0(i+1,j+1), A1(i+1,j+1), A2(i+1,j+1), A3(i+1,j+1).

When there are different distances Z₁, Z₂, and Z₃ between the depth sensor 10 and the target object 40, a digital signal processor (not shown) calculates a distance Z using the digital depth pixel signals A0, A1, A2, and A3.

For instance, when the modulated optical signal (e.g., the clock signal MLS) is cos ωt and an optical signal input to the 2-tap depth pixel 23 or an optical signal (e.g., A0, A1, A2, or A3) detected by the 2-tap depth pixel 23 is cos(ωt+θ), a phase shift or difference θ led by TOF is expressed by Equation 8:

θ=arctan((A3−A1)/(A2−A0)) (8)

where (A3−A1) indicates a first differential pixel signal and (A2−A0) indicates a second differential pixel signal. Accordingly, the distance Z from the light source 32 or the array 22 to the target object 40 is calculated using Equation 9:

Z=θ*C/(2*ω)=θ*C/(2*(2πf) (9)

where C is the speed of light.

When the digital signal processor calculates the distance Z, an error may occur due to noise of a plurality of digital pixel signals (e.g., A0, A1, A2, and A3). Accordingly, a noise reduction filter 39 for reducing the noise is desirable.

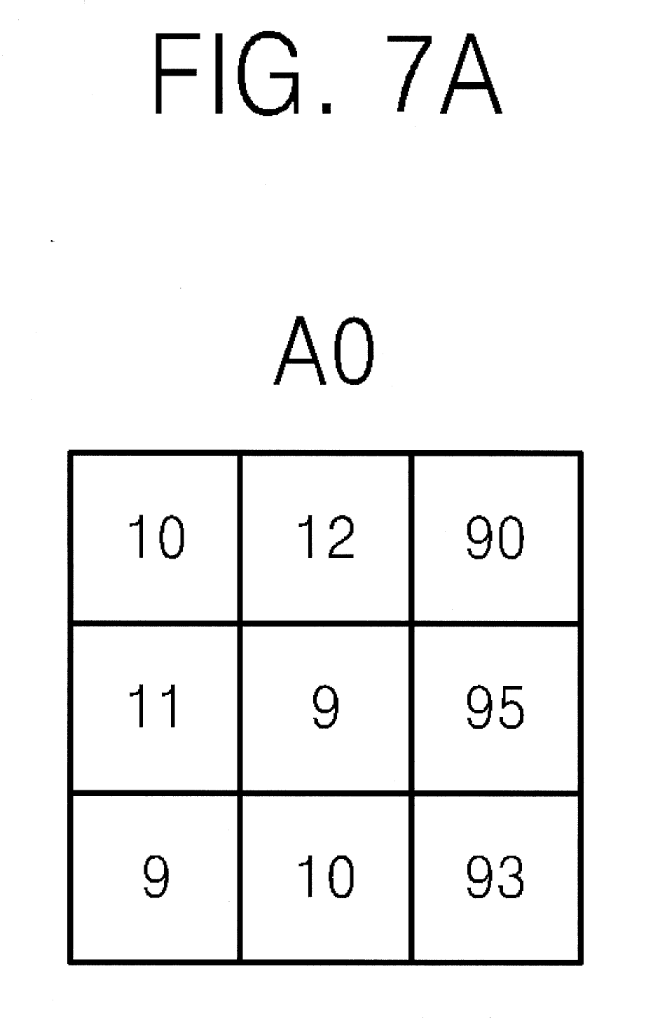

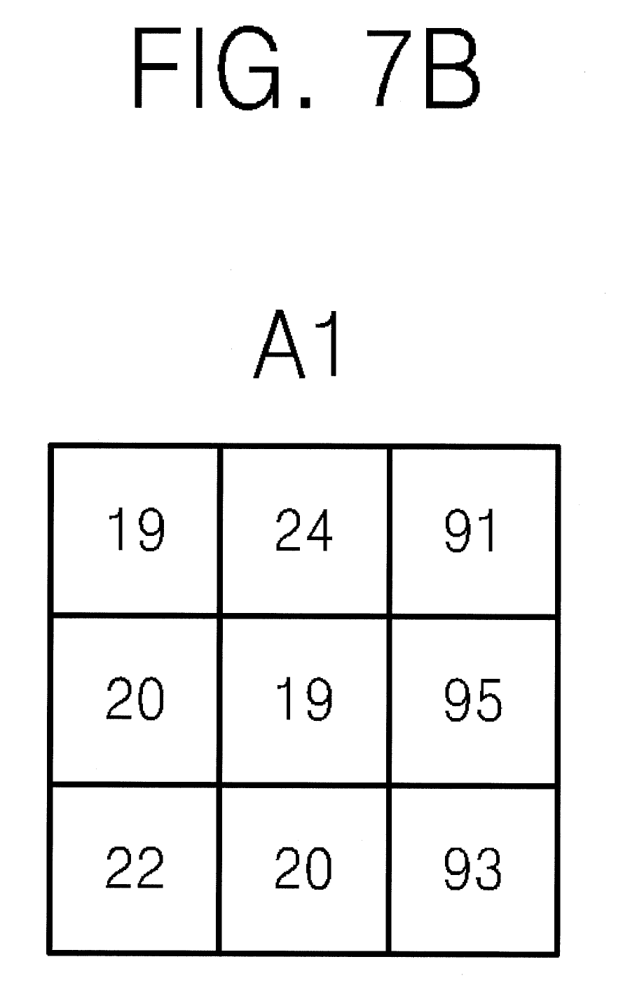

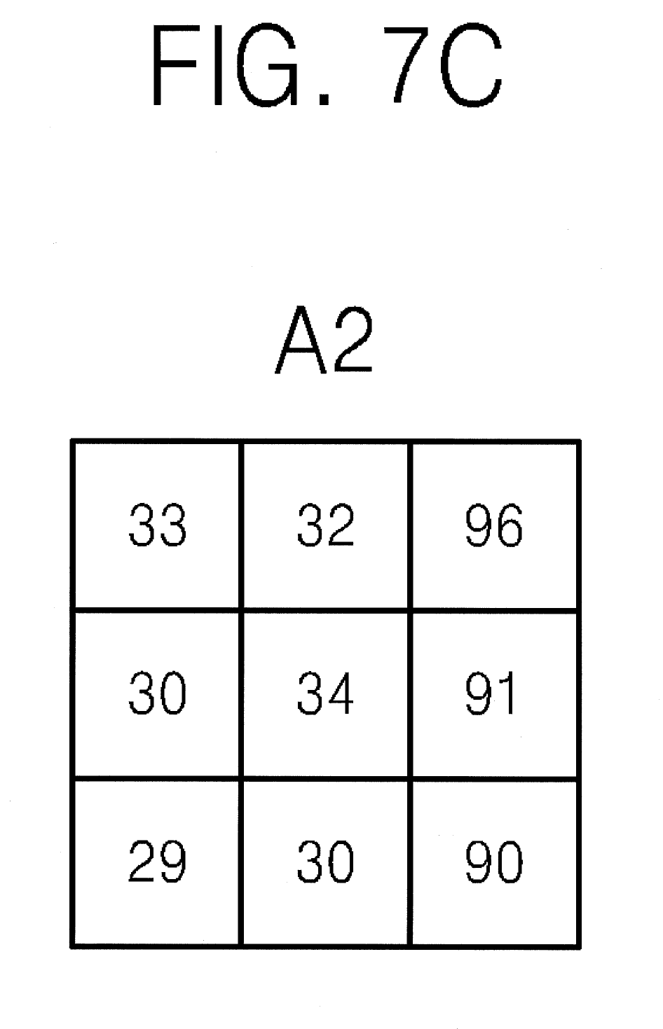

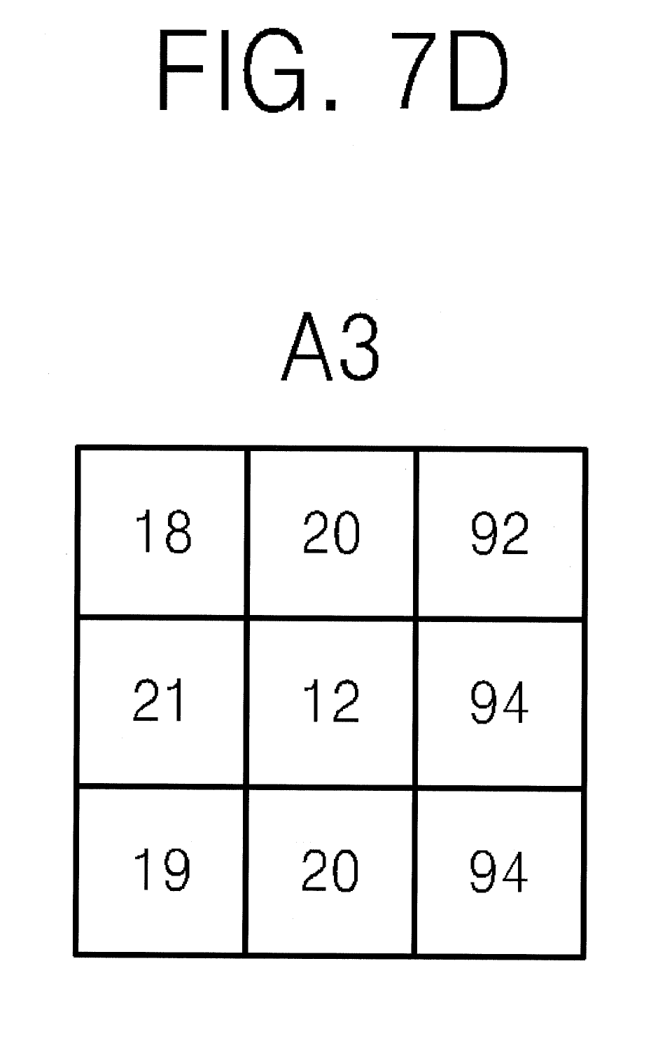

FIG. 7A shows a first digital pixel signal value of each of the pixels illustrated in FIG. 6. FIG. 7B shows a second digital pixel signal value of each of the pixels illustrated in FIG. 6. FIG. 7C shows a third digital pixel signal value of each of the pixels illustrated in FIG. 6. FIG. 7D shows a fourth digital pixel signal value of each of the pixels illustrated in FIG. 6.

Referring to FIGS. 1 through 7D, the noise reduction filter 39 calculates similarities SA31(i,j,l,m), SA20(i,j,l,m), SA(i,j,l,m), and SB(i,j,l,m) between the digital depth pixel signals A0(i,j), A1(i,j), A2(i,j), and A3(i,j) of the depth pixel 51 and the digital neighbor depth pixel signals A0(i−1,j−1), A1(i−1,j−1), A2(i−1,j−1), A3(i−1,j−1), . . . , A0(i+1,j+1), A1(i+1,j+1), A2(i+1,j+1), A3(i+1,j+1) of the neighbor depth pixels 53. Here, (l,m) is one among (i−1,j−1), (i−1,j), (i−1,j+1), (i,j−1), (i,j+1), (i+1,j−1), (i+1,j), and (i+1,j+1).

The similarities SA31(i,j,l,m), SA20(i,j,l,m), SA(i,j,l,m), and SB(i,j,l,m) include the first similarity SA31(i,j,l,m), the second similarity SA20(i,j,l,m), the third similarity SA(i,j,l,m), and the fourth similarity SB(i,j,l,m).

The first similarity SA31(i,j,l,m) indicates the similarity between a first differential digital pixel signal A31(i,j) of the depth pixel 51 and each of first differential digital pixel signals A31(i−1,j−1), A31(i−1,j), A31(i−1,j+1), A31(i,j−1), A31(i,j+1), A31(i+1,j−1), A31(i+1,j), and A31(i+1,j+1) of the respective neighbor depth pixels 53.

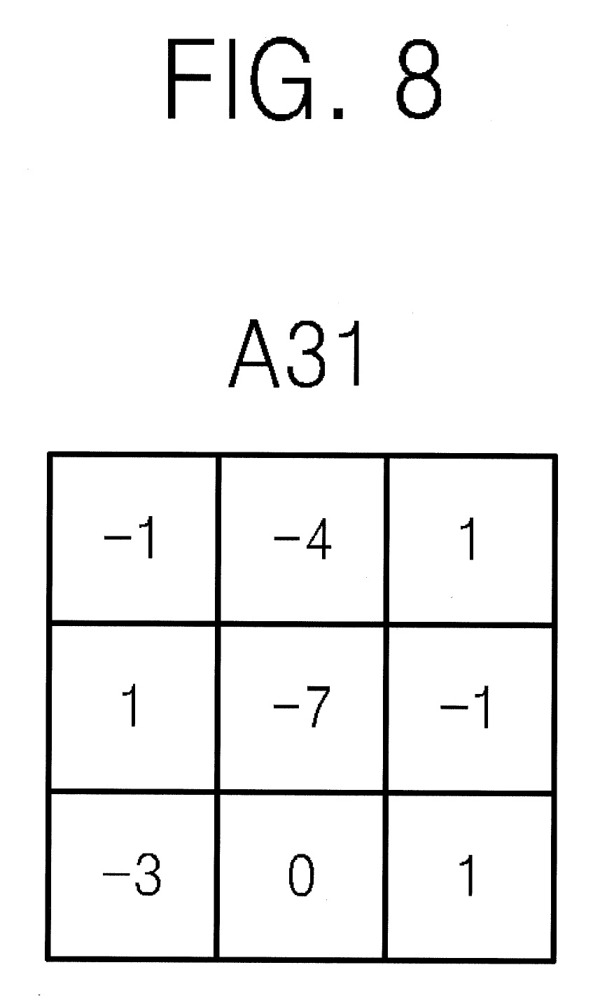

FIG. 8 is a diagram showing the first differential digital pixel signal of each of the pixels illustrated in FIG. 6. Referring to FIGS. 1 through 8, the first differential digital pixel signal A31(i,j) of the depth pixel 51 and the first differential digital pixel signals A31(l,m) of the respective neighbor depth pixel 53 are calculated by respectively subtracting second digital pixel signals A1(i−1,j−1), A1(i−1, j), . . . , A1(i+1,j+1) detected by the depth pixels 51 and 53 from fourth digital pixel signals A3(i−1,j−1), A3(i−1, j), . . . , A3(i+1,j+1) detected by the depth pixels 51 and 53. For instance, when A3(i, j) is 12 and A1(i, j) is 19, A31(i, j) is −7.

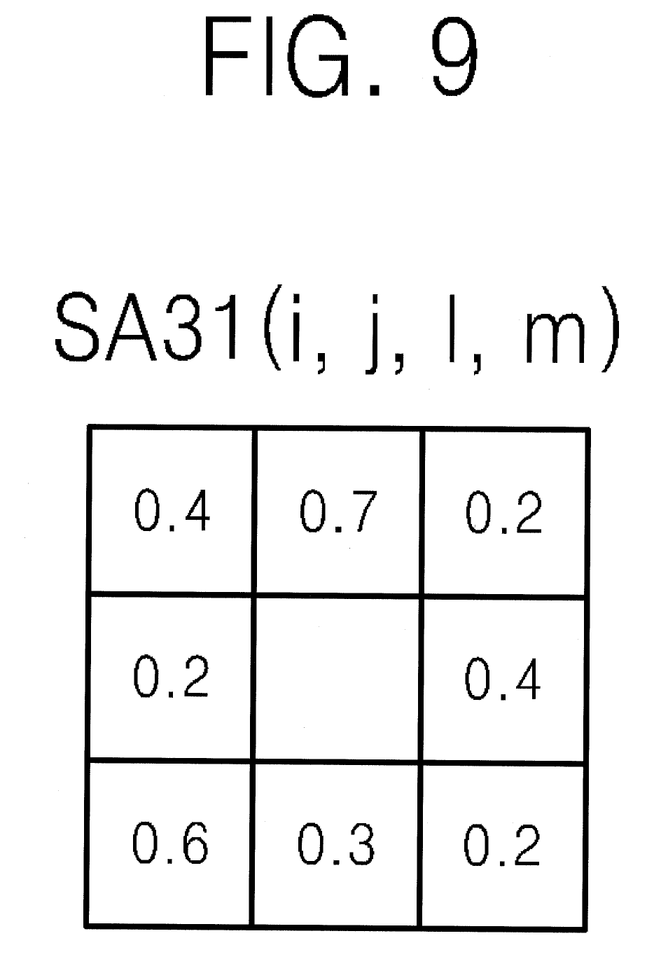

FIG. 9 is a diagram showing the first similarity SA31(i,j,l,m) of each of the neighbor depth pixels 53 illustrated in FIG. 6. Referring to FIGS. 1 through 9, the first similarity SA31(i,j,l,m) is calculated using Equation 10:

SA31(i,j,l,m)=1−min((|A31(i, j)−A31(l,m)|*WA31,1) (10)

where WA31 is a similarity weight coefficient of the first similarity SA31(i,j,l,m). For instance, W31 is 0.1. A low value of the similarity weight coefficient increases similarity but may cause image loss. When |A31(i, j)−A31(l,m)*WA31>=1, A31(i,j) is dissimilar to A31(l,m).

The similarity weight coefficient may be determined through an experiment in which the similarity weight coefficient of the first similarity is adjusted to reduce maximum noise while edge blur is being prevented.

For instance, the standard deviation σ(i,j,l,m) may be calculated using Equation 11.

σ(i,j,l,m)=a+b+(A31(i,j)+A31(l,m))/2 (11)

where “a” and “b” are curve fitting coefficients.

When A31(i,j) is at an image boundary, the value of A31(l,m) may not exist. In this case, SA31(i,j,l,m) is set to 0.

For instance, when A31(i,j) is −7 and A31(i−1,j−1) is −1, SA31(i,j, i−1, j−1) is calculated as shown in Equation 12:

SA31(i, j, i−1, j−1)=1−min((|−7−(−1)|*0.1, 1)=0.4 . (12)

The first similarity SA31(i,j,l,m) between the depth pixel 51 and each of the neighbor depth pixels 53 may be calculated in a similar manner.

The second similarity SA20(i,j,l,m) indicates the similarity between a second differential digital pixel signal A20(i,j) of the depth pixel 51 and each of second differential digital pixel signals A20(i−1,j−1), A20(i−1,j), A20(i−1,j+1), A20(i,j−1), A20(i,j+1), A20(i+1,j−1), A20(i+1,j), and A20(i+1,j+1) of the respective neighbor depth pixels 53.

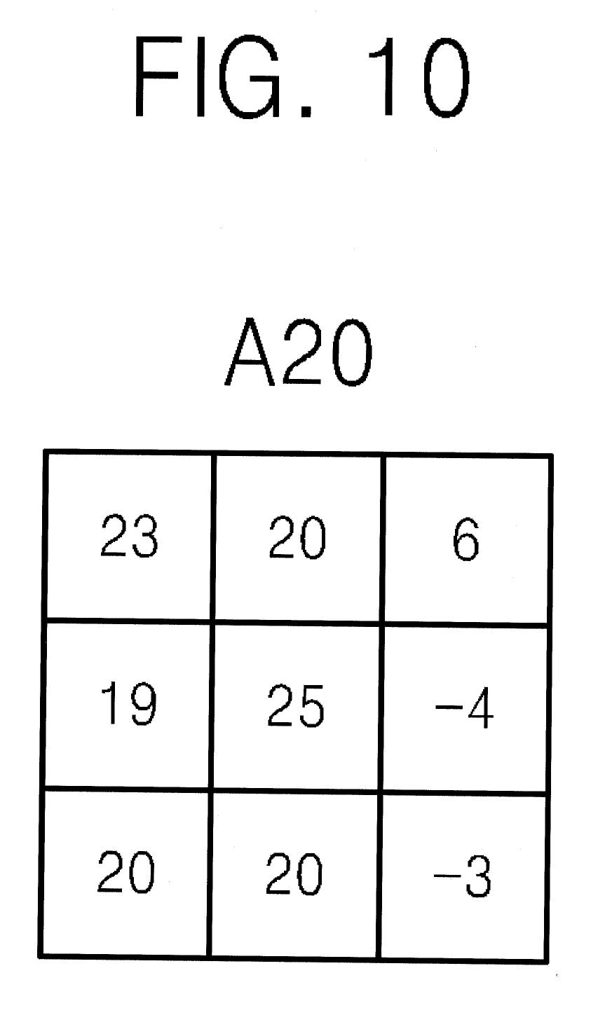

FIG. 10 is a diagram showing the second differential digital pixel signal of each of the pixels illustrated in FIG. 6. Referring to FIGS. 1 through 10, the second differential digital pixel signal A20(i,j) of the depth pixel 51 and the second differential digital pixel signals A20(i−1,j−1), A20(i−1,j), A20(i−1,j+1), A20(i,j−1), A20(i,j+1), A20(i+1,j−1), A20(i+1,j), and A20(i+1,j+1) of the respective neighbor depth pixel 53 are calculated by respectively subtracting first digital pixel signals A0(i−1,j−1), A0(i−1, j), A0(i−1,j+1), A0(i,j−1), A0(i,j), A0(i,j+1), A0(i+1,j−1), A0(i+1,j), and A0(i+1,j+1) from third digital pixel signals A2(i−1,j−1), A2(i−1, j), A2(i−1,j+1), A2(i,j−1), A2(i,j), A2(i,j+1), A2(i+1,j−1), A2(i+1,j), and A2(i+1,j+1), among the plurality of digital pixel signals detected at the depth pixels 51 and neighbor depth pixels 53. For instance, when A2(i, j) is 34 and A0(i, j) is 9, A20(i, j) is 25.

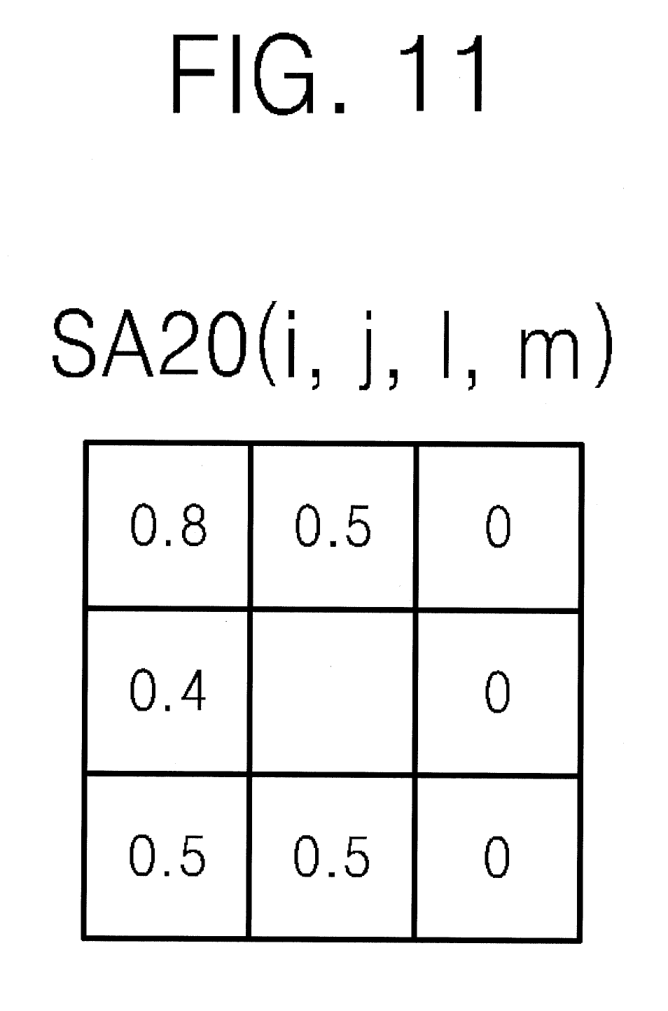

FIG. 11 is a diagram showing the second similarity SA20(i,j,l,m) of each of the neighbor depth pixels 53 illustrated in FIG. 6. Referring to FIGS. 1 through 11, the second similarity SA20(i,j,l,m) is calculated using Equation 13:

SA20(i, j,l,m)=1−min((|A20(i, j)−A20(l, m)|*WA20, 1) (13)

where WA20 is a similarity weight coefficient of the second similarity SA20(i,j,l,m). The similarity weight coefficient may be an empirically determined design parameter.

For instance, when A20(i,j) is 25, A20(i−1,j−1) is 23, and WA20 is 0.1, SA20(i,j, i−1, j−1) is calculated as shown in Equation 14:

SA20(i, j, i−1, j−1)=1−min((|25−(23)|*0.1, 1)=0.8. (14)

The second similarity SA20(i,j,l,m) between the depth pixel 51 and each of the neighbor depth pixels 53 may be calculated in a similar manner.

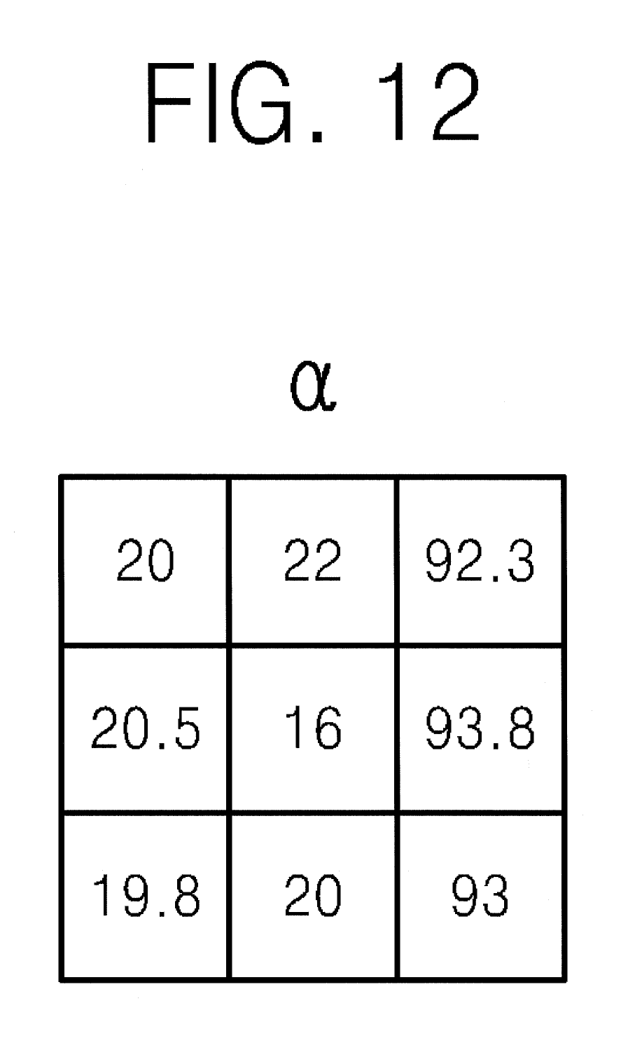

FIG. 12 is a diagram showing an amplitude of each of the pixels illustrated in FIG. 6. Referring to FIGS. 1 through 12, the third similarity SA(i,j,l,m) is the similarity between an amplitude A(i,j) of the depth pixel 51 and each of amplitudes A(i−1,j−1), A(i−1,j), A(i−1,j+1), A(i,j−1), A(i,j+1), A(i+1,j−1), A(i+1,j), and A(i+1,j+1) of the respective neighbor depth pixels 53. The amplitude A(i,j) of the depth pixel 51 and the amplitudes A(i−1,j−1), A(i−1,j), A(i−1,j+1), A(i,j−1), A(i,j+1), A(i+1,j−1), A(i+1,j), and A(i+1,j+1) of the respective neighbor depth pixels 53 are calculated using Equation 6 described above.

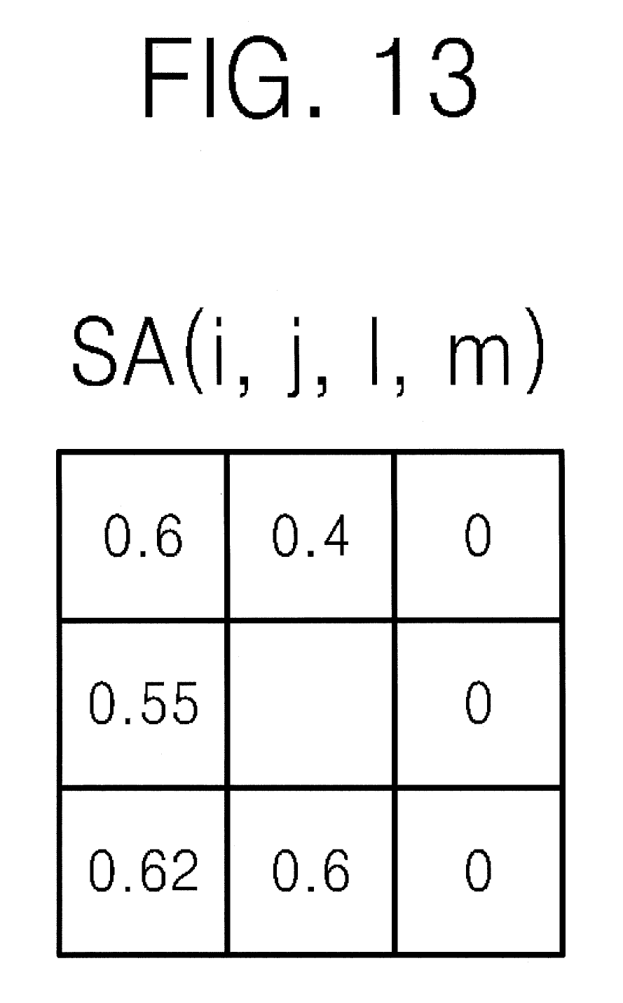

FIG. 13 is a diagram showing the third similarity SA(i,j,l,m) of each of the neighbor depth pixels 53 illustrated in FIG. 6. Referring to FIGS. 1 through 13, the third similarity SA(i,j,l,m) is calculated using Equation 15:

SA(i, j,l,m)=1−min((|A(i,j)−A(l,m)|*WA, 1) (15)

where WA is a similarity weight coefficient of an amplitude. The similarity weight coefficient may be an empirically determined design parameter. For instance, when the amplitude A(i,j) of the depth pixel 51 is 16, the amplitude A(i−1,j−1) of one of the neighbor depth pixels 53 is 20, and the similarity weight coefficient WA of the amplitude is 0.1, the third similarity SA(i,j,i−1,j−1) is calculated as shown in Equation 16:

SA(i,j,i−1,j−1)=1−min((|16−20|*0.1, 1)=0.6. (16)

The third similarity SA(i,j,l,m) between the depth pixel 51 and each of the neighbor depth pixels 53 may be calculated in a similar manner.

The fourth similarity SB(i,j,l,m) is the similarity between an offset B(i,j) of the depth pixel 51 and each of offsets B(i−1,j−1), B(i−1,j), B(i−1,j+1), B(i,j−1), B(i,j+1), B(i+1,j−1), B(i+1,j), and B(i+1,j+1) of the respective neighbor depth pixels 53.

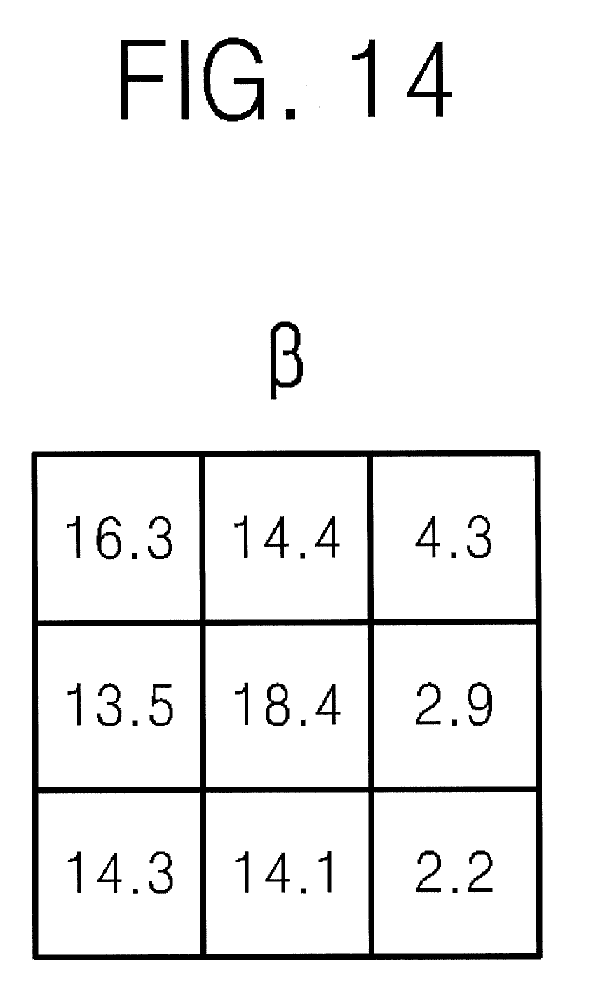

FIG. 14 is a diagram showing an offset of each of the pixels illustrated in FIG. 6. Referring to FIGS. 1 through 14, the offset B(i,j) of the depth pixel 51 and the offsets B(i−1,j−1), B(i−1,j), B(i−1,j+1), B(i,j−1), B(i,j+1), B(i+1,j−1), B(i+1,j), and B(i+1,j+1) of the respective neighbor depth pixels 53 are calculated using Equation 7 described above.

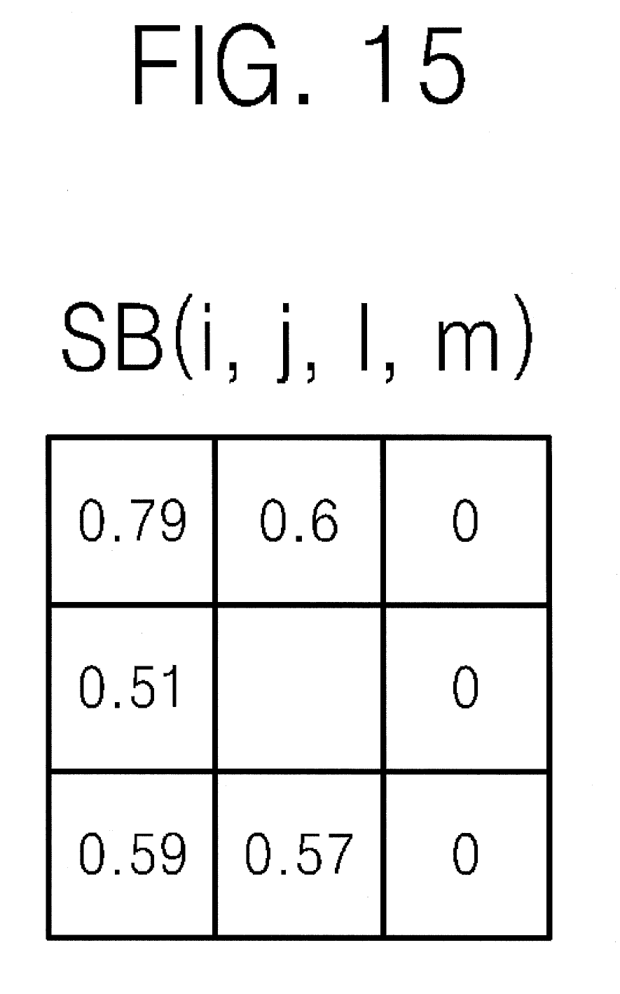

FIG. 15 is a diagram showing the fourth similarity SB(i,j,l,m) of each of the neighbor depth pixels 53 illustrated in FIG. 6. Referring to FIGS. 1 through 15, the fourth similarity SB(i,j,l,m) is calculated using Equation 17:

SB(i,j,l,m)=1−min((|B(i,j)−B(l,m)|*WB,1) (17)

where WB is a similarity weight coefficient of an offset. The similarity weight coefficient may be determined an empirically determined design parameter. For instance, when the offset B(i,j) of the depth pixel 51 is 18.4, the offset B(i−1,j−1) of one of the neighbor depth pixels 53 is 16.3, and the similarity weight coefficient WB of the offset is 0.1, the fourth similarity SB(i,j,i−1,j−1) is calculated as shown in Equation 18:

SB(i,j,i−1,j−1)=1−min((|18.4−16.3|*0.1,1)=0.79. (18)

The fourth similarity SB(i,j,l,m) between the depth pixel 51 and each of the neighbor depth pixels 53 may be calculated in a similar manner. The noise reduction filter 39 calculates a weight w(i,j,l,m) of each neighbor depth pixel 53 using the similarities.

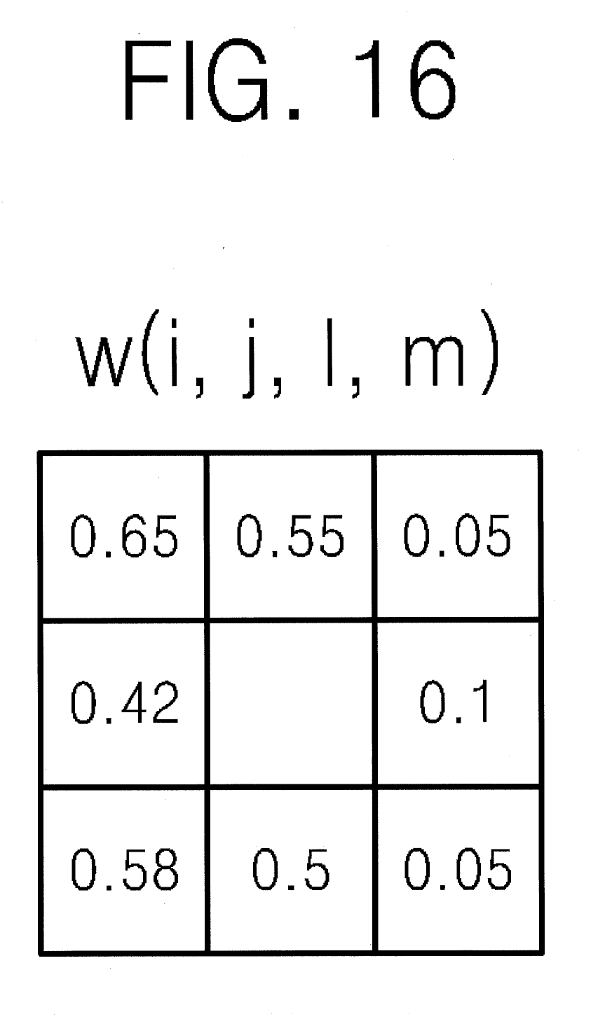

FIG. 16 is a diagram showing the weight w(i,j,l,m) of each of the neighbor depth pixels 53 illustrated in FIG. 6. Referring to FIGS. 1 through 16, the weight w(i,j,l,m) of each neighbor depth pixel 53 is calculated using Equation 19:

w(i,j ,l,m)=RA31*SA31(i,j ,l,m)+RA20*SA20(i,j ,l,m)+RA*SA(i,j ,l,m)+RB*SB(i,j,l,m) (19)

where RA31, RA20, RA, and RB are weight coefficients. The relationship among the weight coefficients are expressed by Equation 20:

RA31+RA20+RA+RB=1. (20)

The weight coefficients may be empirically determined design parameters. For instance, when each of the weight coefficients RA31, RA20, RA, and RB is 0.25, the first similarity SA31(i,j,i−1,j−1) between the depth pixel 51 and one of the neighbor depth pixels 53 is 0.4, the second similarity SA20(i,j,i−1,j−1) between the depth pixel 51 and the one of the neighbor depth pixels 53 is 0.8, the third similarity SA(i,j,i−1,j−1) between the depth pixel 51 and the one of the neighbor depth pixels 53 is 0.79, and the fourth similarity SB(i,j,i−1,j−1) between the depth pixel 51 and the one of the neighbor depth pixels 53 is 0.6, a weight w(i,j,i−1,j−1) of the one of the neighbor depth pixels 53 is calculated as shown in Equation 21:

w(i,j,i−1,j−1)=0.25*0.4+0.25*0.8+0.25*0.79+0.25*0.6=0.65. (21)

In a similar manner, the weight w(i,j,l,m) of each neighbor depth pixel 53 may be calculated.

Alternatively, the weight w(i,j,l,m) may be calculated using Equation 22:

w(i,j,l,m)=SA31(i,j,l,m)̂RA31*SA20(i,j,l,m)̂RA20*SA(i,j ,l,m)̂RA*SB(i,j,l,m)̂RB. (22)

In this embodiment, the weight coefficients RA31, RA20, RA, and RB are non-negative. For instance, each of the weight coefficients RA31, RA20, RA, and RB is 1. The weight coefficients may be empirically determined design parameters.

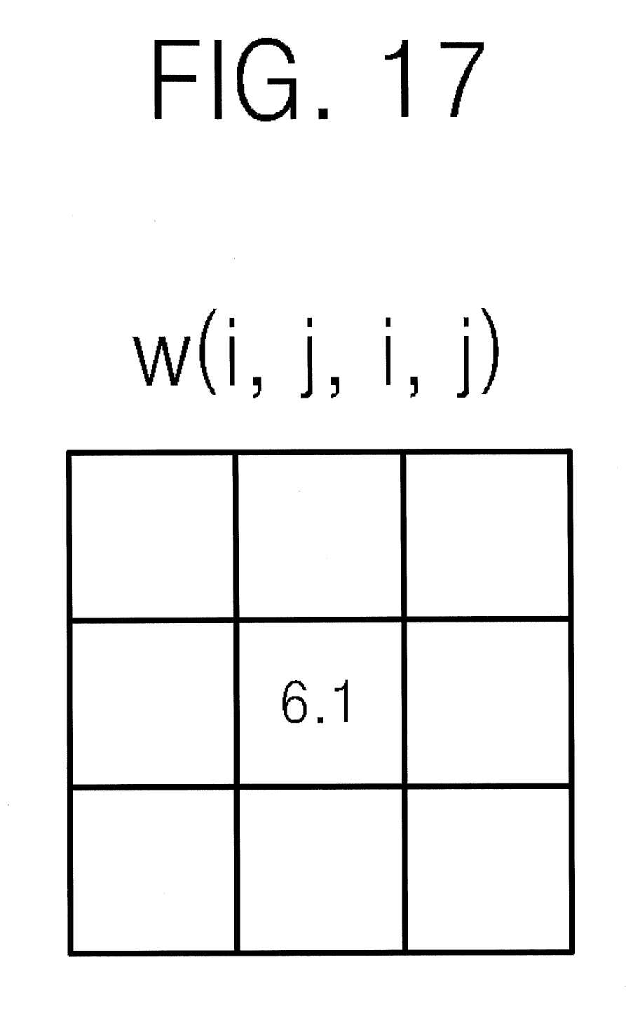

FIG. 17 is a diagram showing a weight w(i,j,i,j) of the depth pixel 51 illustrated in FIG. 6. Referring to FIGS. 1 through 17, the noise reduction filter 39 calculates the weight w(i,j,i,j) of the depth pixel 51 using the weight w(i,j,l,m) of each neighbor depth pixel 53.

The weight w(i,j,i,j) of the depth pixel 51 is calculated using Equation 23:

w(i,j,i,j)=K*L−sum(w(i,j,l,m)) (23)

where K*L indicates a K×L pixel array and sum(w(i,i,l,m)) is the sum of the weights w(i,j,l,m) of the respective neighbor depth pixels 53. Here, K and L are natural numbers.

For instance, when the pixel array is 3×3 and the weights w(i,j,l,m) of the respective neighbor depth pixels 53 are 0.65, 0.55, 0.05, 0.42, 0.1, 0.58, 0.5, and 0.05, the weight w(i,j,i,j) of the depth pixel 51 is calculated as shown in Equation 24:

w(i,j,i,j)=9−(0.65+0.55+0.05+0.42+0.1+0.58+0.5+0.05)=9−2.9=6.1. (24)

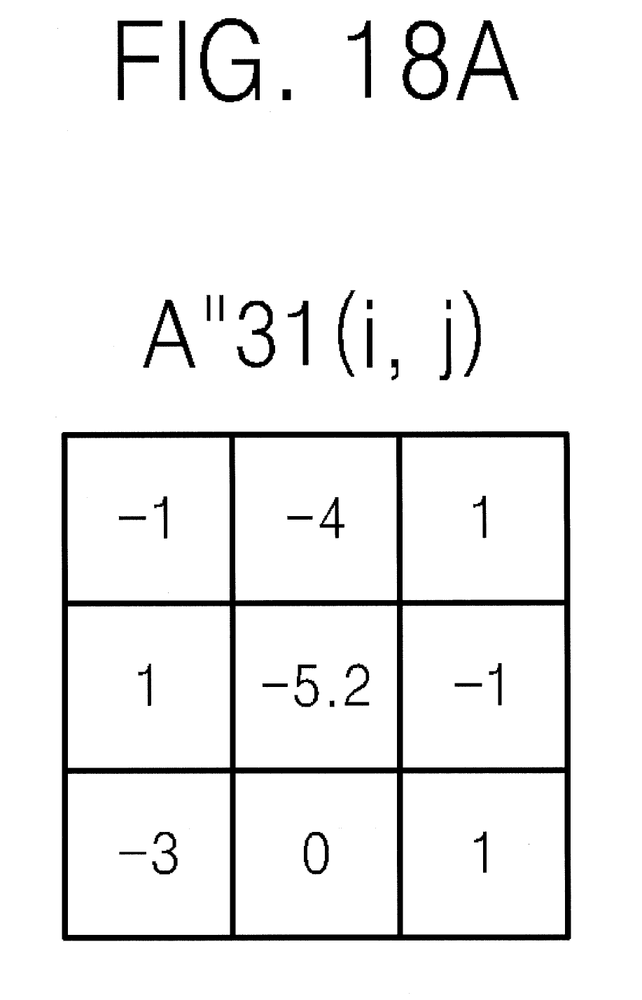

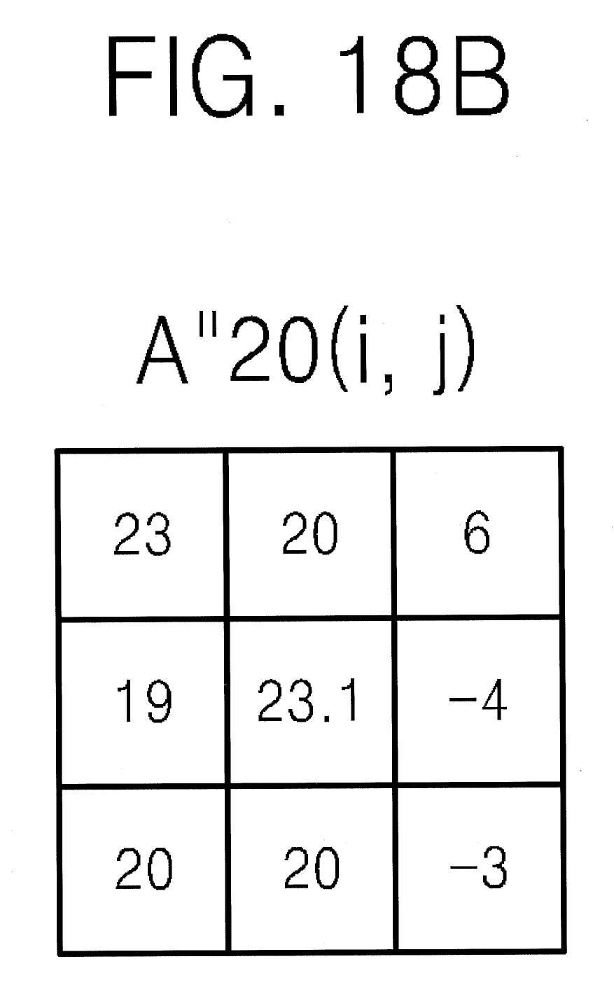

FIGS. 18A and 18B are diagrams showing denoised pixel signals of the depth pixel 51 illustrated in FIG. 6. FIG. 18A shows a denoised first differential digital pixel signal A″31(i,j) of the depth pixel 51 illustrated in FIG. 6. FIG. 18B shows a denoised second differential digital pixel signal A″20(i,j) of the depth pixel 51 illustrated in FIG. 6. Referring to FIGS. 1 through 18B, the noise reduction filter 39 calculates the denoised pixel signal A″31(i,j) or A″20(i,j) using the weights w(i,j,l,m) of the respective neighbor depth pixels 53 and the weight w(i,j,i,j) of the depth pixel 51.

The denoised pixel signals A″31(i,j) and A″20(i,j) are respectively calculated using Equations 25 and 26:

A″31(i,j)=(sum(w(i,j,l,m)*A31(l,m))+w(i,j,i,j)*A31(i,j))/(K*L), (25)

A″20(i,j)=(sum(w(i,j,l,m)*A20(l,m))+w(i,j,i,j)*A20(i,j))/(K*L) (26)

where K*L indicates a K×L pixel array, sum(w(i,i,l,m)) is the sum of the weights w(i,j,l,m) of the respective neighbor depth pixels 53, A31(l,m) and A20(l,m) indicate the first and second differential digital pixel signals, respectively, of each neighbor depth pixel 53, and A31(i,j) and A20(i,j) indicate the first and second differential digital pixel signals, respectively, of the depth pixel 51.

For instance, when the pixel array is 3×3, the weights w(i,j,l,m) of the respective neighbor depth pixels 53 are 0.65, 0.55, 0.05, 0.42, 0.1, 0.58, 0.5, and 0.05, the weight w(i,j,i,j) of the depth pixel 51 is 6.1, the first differential digital pixel signals A31(l,m) of the respective neighbor depth pixels 53 are −1, −4, 1, 1, −1, −3, 0, and 1, and the first differential digital pixel signal A31(i,j) of the depth pixel 51 is −7, the denoised pixel signal A″31(i,j) is calculated as shown in Equation 27:

A″31(i,j)=(0.65*(−1)+0.55*(−4)+0.05*1+0.42*1+6.1*(−7)+0.1*(−1)+0.58*(−3)+0.5*0+0.05*1)/9=−5.18 (27)

For instance, when the pixel array is 3×3, the weights w(i,j,l,m) of the respective neighbor depth pixels 53 are 0.65, 0.55, 0.05, 0.42, 0.1, 0.58, 0.5, and 0.05, the weight w(i,j,i,j) of the depth pixel 51 is 6.1, the second differential digital pixel signals A20(l,m) of the respective neighbor depth pixels 53 are 23, 20, 6, 19, −4, 20, 20, and −3, and the second differential digital pixel signal A20(i,j) of the depth pixel 51 is 25, the denoised pixel signal A″20(i,j) is calculated as shown in Equation 28:

A″20(i,j)=(0.65*23+0.55*20+0.05*6+0.42*19+6.1*25+0.1*(−4)+0.58*20+0.5*20+0.05*(−3))/9=22.97 (28)

Accordingly, the noise reduction filter 39 may calculate a noise-reduced first differential digital pixel signal or a noise-reduced second differential digital pixel signal using Equation 25 or 26, respectively.

The noise reduction filter 39 performs the above-described calculations using the noise-reduced differential digital pixel signal as one of the first and second differential pixel signals of the depth pixel 51 and generates an updated first or second differential pixel signal. The noise reduction filter 39 may repeatedly perform the calculations.

A digital signal processor (not shown) may calculate a distance using the updated first and second differential pixel signals.

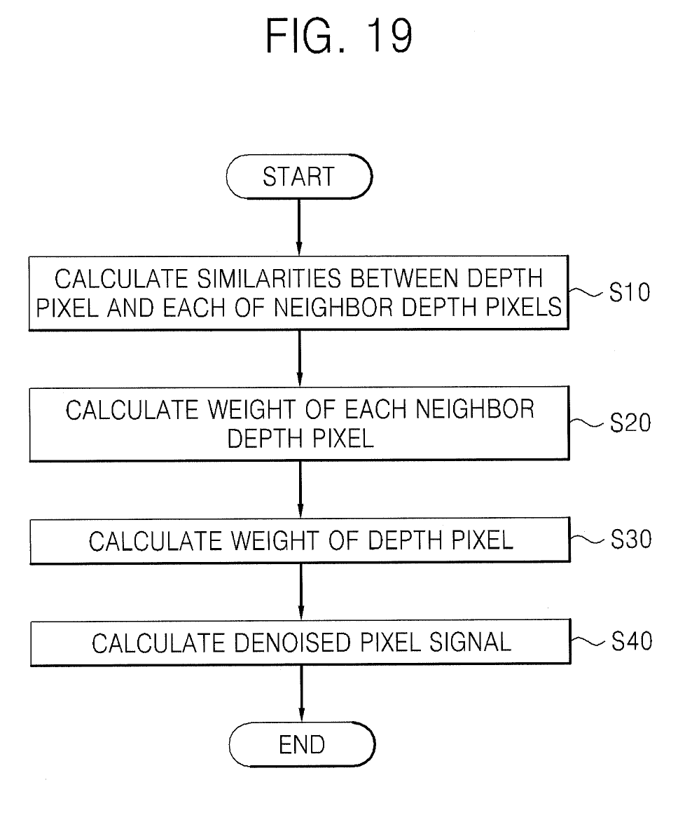

FIG. 19 is a flowchart of a method of reducing noise of the depth sensor 10 according to an example embodiment. Referring to FIGS. 1 through 19, the noise reduction filter 39 calculates the similarities SA31(i,j,l,m), SA20(i,j,l,m), SA(i,j,l,m), and SB(i,j,l,m) between the digital pixel signals A0(i,j), A1(i,j), A2(i,j), and A3(i,j) of the depth pixel 51 and the digital pixel signals A0(i−1,j−1), A1(i−1,j−1), A2(i−1,j−1), A3(i−1,j−1), . . . ,_A0(i+1,j+1), A1(i+1,j+1), A2(i+1,j+1), A3(i+1,j+1) of the neighbor depth pixels 53 in operation S10.

The similarities SA31(i,j,l,m), SA20(i,j,l,m), SA(i,j,l,m), and SB(i,j,l,m) include the first similarity SA31(i,j,l,m), the second similarity SA20(i,j,l,m), the third similarity SA(i,j,l,m), and the fourth similarity SB(i,j,l,m).

The first similarity SA31(i,j,l,m) indicates the similarity between the first differential digital pixel signal A31(i,j) of the depth pixel 51 and each of the first differential digital pixel signals A31(i−1,j−1), A31(i−1,j), A31(i−1,j+1), A31(i,j−1), A31(i,j+1), A31(i+1,j−1), A31(i+1,j), and A31(i+1,j+1) of the respective neighbor depth pixels 53. The first similarity SA31(i,j,l,m) is calculated using Equation 10 described above.

The second similarity SA20(i,j,l,m) indicates the similarity between the second differential digital pixel signal A20(i,j) of the depth pixel 51 and each of the second differential digital pixel signals A20(i−1,j−1), A20(i−1,j), A20(i−1,j+1), A20(i,j−1), A20(i,j+1), A20(i+1,j−1), A20(i+1,j), and A20(i+1,j+1) of the respective neighbor depth pixels 53. The second similarity SA20(i,j,l,m) is calculated using Equation 13 described above.

The third similarity SA(i,j,l,m) is the similarity between the amplitude A(i,j) of the depth pixel 51 and each of the amplitudes A(i−1,j−1), A(i−1,j), A(i−1,j+1), A(i,j−1), A(i,j+1), A(i+1,j−1), A(i+1,j), and A(i+1,j+1) of the respective neighbor depth pixels 53. The third similarity SA(i,j,l,m) is calculated using Equation 15 described above.

The fourth similarity SB(i,j,l,m) is the similarity between the offset B(i,j) of the depth pixel 51 and each of the offsets B(i−1,j−1), B(i−1,j), B(i−1,j+1), B(i,j−1), B(i,j+1), B(i+1,j−1), B(i+1,j), and B(i+1,j+1) of the respective neighbor depth pixels 53. The fourth similarity SB(i,j,l,m) is calculated using Equation 17 described above.

The noise reduction filter 39 calculates the weights w(i,j,l,m) of the respective neighbor depth pixels 53 using the similarities SA31(i,j,l,m), SA20(i,j,l,m), SA(i,j,l,m), and SB(i,j,l,m) in operation S20. The weight w(i,j,l,m) of each neighbor depth pixel 53 is calculated using Equation 19. The noise reduction filter 39 calculates the weight w(i,j,i,j) of the depth pixel 51 using the weights w(i,j,l,m) of the respective neighbor depth pixels 53 in operation S30.

The weight w(i,j,i,j) of the depth pixel 51 is calculated using Equation 23.

The noise reduction filter 39 calculates the denoised pixel signal A″31(i,j) or A″20(i,j) using the weight w(i,j,i,j) of the depth pixel 51 and the weights w(i,j,l,m) of the respective neighbor depth pixels 53 in operation S40

The denoised pixel signal A″31(i,j) or A″20(i,j) is calculated using Equation 25 or 26.

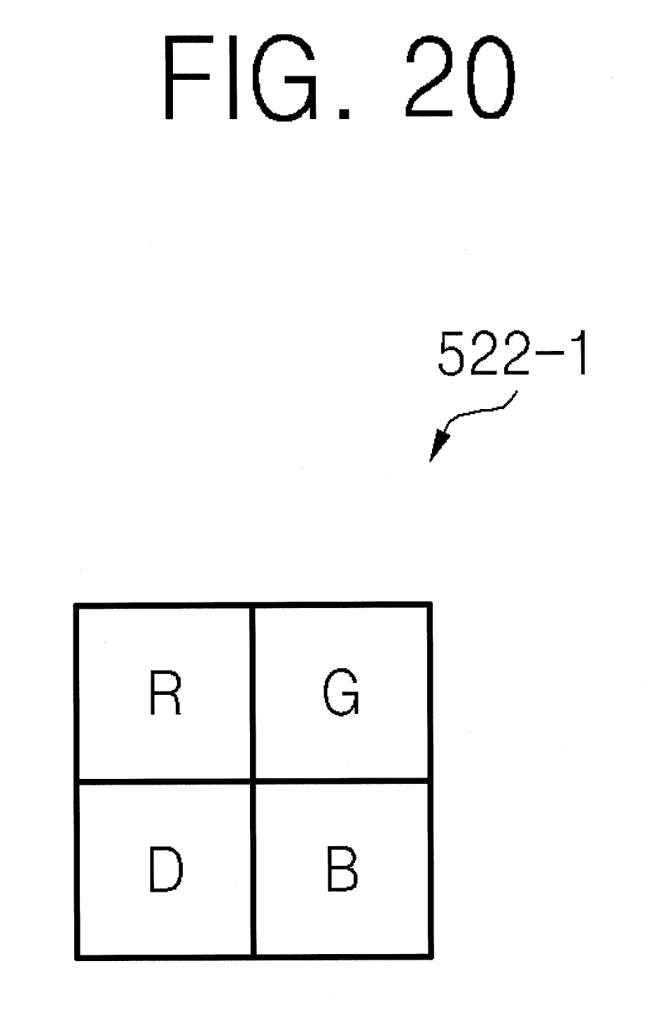

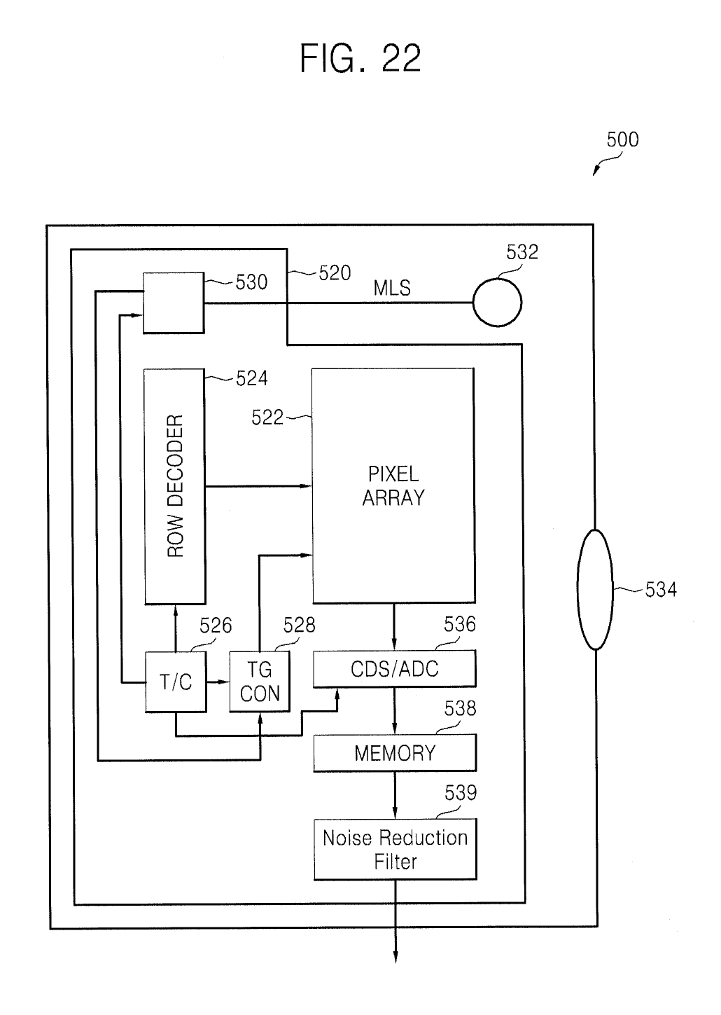

FIG. 20 is a diagram of a unit pixel array 522-1 of a three-dimensional (3D) image sensor according to an example embodiment. Referring to FIG. 20, the unit pixel array 522-1 forming a part of a pixel array 522 illustrated in FIG. 22 may include a red pixel R, a green pixel G, a blue pixel B, and a depth pixel D. The depth pixel D may be the depth pixel 23 having a 2-tap structure, as illustrated in FIG. 1, or a depth pixel (not shown) having a 1-tap structure. The red pixel R, the green pixel G, and the blue pixel B may be referred to as RGB color pixels.

The red pixel R generates a red pixel signal corresponding to wavelengths in a red range of a visible spectrum. The green pixel G generates a green pixel signal corresponding to wavelengths in a green range of the visible spectrum. The blue pixel B generates a blue pixel signal corresponding to wavelengths in a blue range of the visible spectrum. The depth pixel D generates a depth pixel signal corresponding to wavelengths in an infrared spectrum.

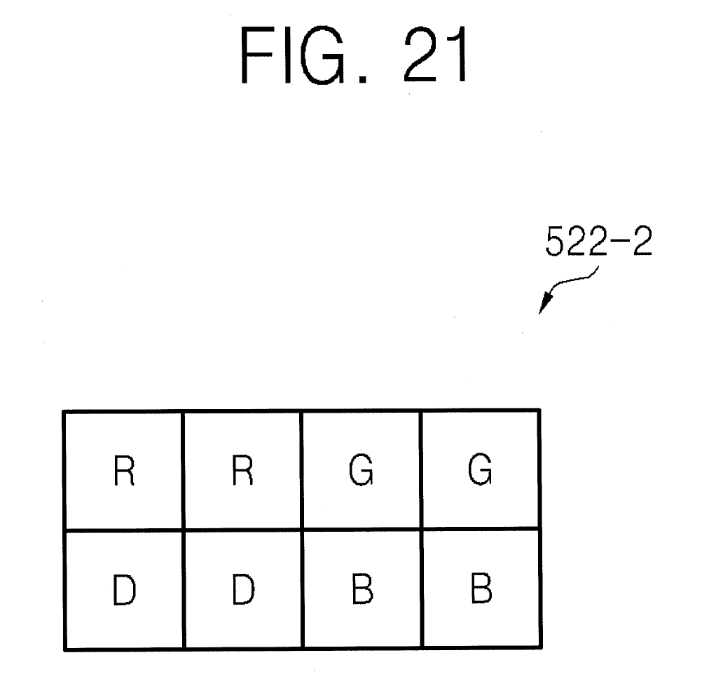

FIG. 21 is a diagram of a unit pixel array 522-2 of a 3D image sensor according to an example embodiment. Referring to FIG. 21, the unit pixel array 522-2 faulting a part of the pixel array 522 illustrated in FIG. 22 may include two red pixels R, two green pixels G, two blue pixels B, and two depth pixels D.

The unit pixel arrays 522-1 and 522-2 illustrated in FIGS. 20 and 21 are exemplarily shown for clarity of the description. The pattern of a unit pixel array and pixels forming the pattern may vary with embodiments. For instance, the pixels R, G, and B illustrated in FIGS. 20 and 21 may be replaced by a magenta pixel, a cyan pixel, and a yellow pixel.

FIG. 22 is a block diagram of a 3D image sensor 500 according to another embodiment. Here, the 3D image sensor 500 is a device that obtains 3D image information by combining a function of measuring depth information using the depth pixel D included in the unit pixel array 522-1 or 522-2 illustrated in FIG. 20 or 21 and a function of measuring color information (e.g., red color information, green color information, or blue color information) using each of the color pixels R, G, and B.

Referring to FIG. 22, the 3D image sensor 500 includes a semiconductor chip 520, a light source 532, and a lens module 534. The semiconductor chip 520 includes the pixel array 522, a row decoder 524, a timing controller 526, a photo gate controller 528, a light source driver 530, a CDS/ADC circuit 536, a memory 538, and a noise reduction filter 539.

The operations and the functions of the row decoder 524, the timing controller 526, the photo gate controller 528, the light source driver 530, the CDS/ADC circuit 536, the memory 538, and the noise reduction filter 539 illustrated in FIG. 22 are the same as those of the row decoder 24, the timing controller 26, the photo gate controller 28, the light source driver 30, the CDS/ADC circuit 36, the memory 38, and the noise reduction filter 39 illustrated in FIG. 1. Thus, detailed descriptions thereof will be omitted.

The 3D image sensor 500 may also include a column decoder (not shown). The column decoder may decode column addresses output from the timing controller 526 and output column selection signals.

The row decoder 524 may generate control signals for controlling the operations of each pixel included in the pixel array 522, e.g., each of the pixels R, G, B, and D illustrated in FIG. 20 or 21.

The pixel array 522 includes the unit pixel array 522-1 or 522-2 illustrated in FIG. 20 or 21. For instance, the pixel array 522 includes a plurality of pixels. Each of the plurality of pixels may be a combination of at least two pixels among a red pixel, a green pixel, a blue pixel, a depth pixel, a magenta pixel, a cyan pixel, and a yellow pixel. The plurality of pixels may be respectively arranged at intersections between a plurality of row lines and a plurality of column lines in a matrix form.

The memory 538 and the noise reduction filter 539 may be implemented in an image signal processor. At this time, the image signal processor may generate a 3D image signal based on the first differential pixel signal A31 and the second differential pixel signal A20 output from the noise reduction filter 539.

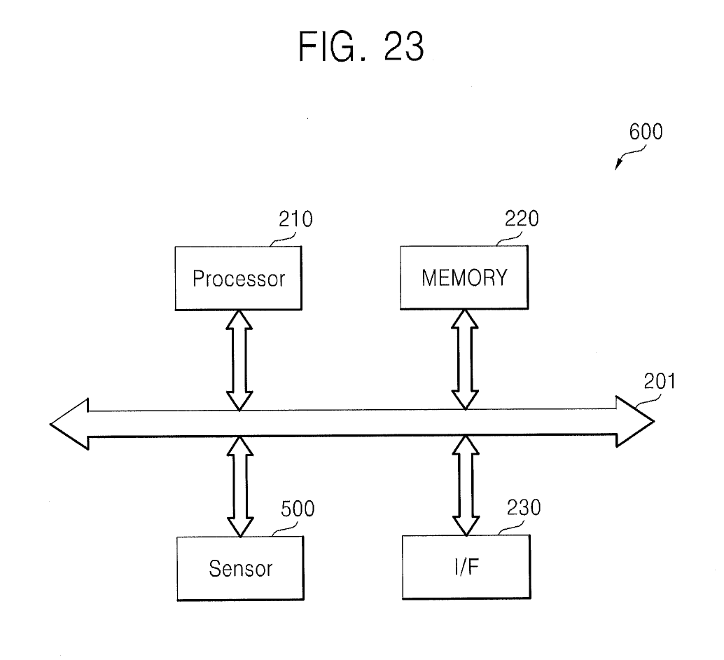

FIG. 23 is a block diagram of an image processing system 600 including the 3D image sensor 500 illustrated in FIG. 22. Referring to FIG. 23, the image processing system 600 may include the 3D image sensor 500 and a processor 210. The processor 210 may control the operations of the 3D image sensor 500. For instance, the processor 210 may store a program for controlling the operations of the 3D image sensor 500. Alternatively, the processor 210 may access a memory (not shown) storing a program for controlling the operations of the 3D image sensor 500 and execute the program stored in the memory.

The 3D image sensor 500 may generate 3D image information based on a digital pixel signal (e.g., color information or depth information) under the control of the processor 210. The 3D image information may be displayed through a display (not shown) connected to an interface (I/F) 230.

The 3D image information generated by the 3D image sensor 500 may be stored in a memory device 220 through a bus 201 under the control, of the processor 210. The memory device 220 may be a non-volatile memory device. The I/F 230 may input and output the 3D image information. The I/F 230 may be implemented as a wireless interface.

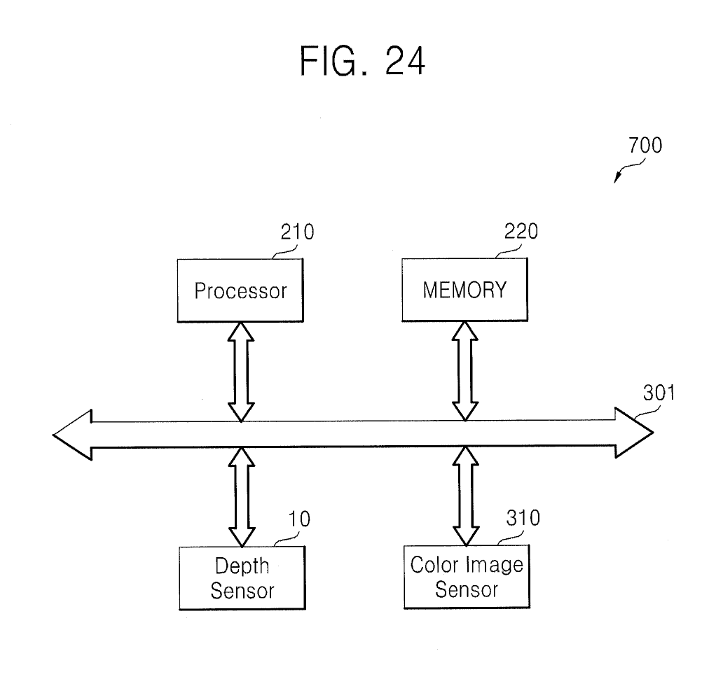

FIG. 24 is a block diagram of an image processing system 700 including a color image sensor 310 and the depth sensor 10 illustrated in FIG. 1. Referring to FIG. 24, the image processing system 700 may include the depth sensor 10, the color image sensor 310, and the processor 210. The depth sensor 10 and the color image sensor 310 are illustrated in FIG. 24 to be physically separated from each other for clarity of the description, but they may physically share signal processing circuits with each other.

The color image sensor 310 may be an image sensor including a pixel array which includes a red pixel, a green pixel, and a blue pixel but not a depth pixel. Accordingly, the processor 210 may generate 3D image information based on depth information estimated or calculated by the depth sensor 10 and color information (e.g., at least one among red information, green information, blue information, magenta information, cyan information, and yellow information) output from the color image sensor 310 and may display the 3D image information through a display.

The 3D image information generated by the processor 210 may be stored in the memory device 220 through a bus 301.

The image processing system 600 or 700 illustrated in FIGS. 23 and 24 may be used for 3D distance meters, game controllers, depth cameras, or gesture sensing apparatuses.

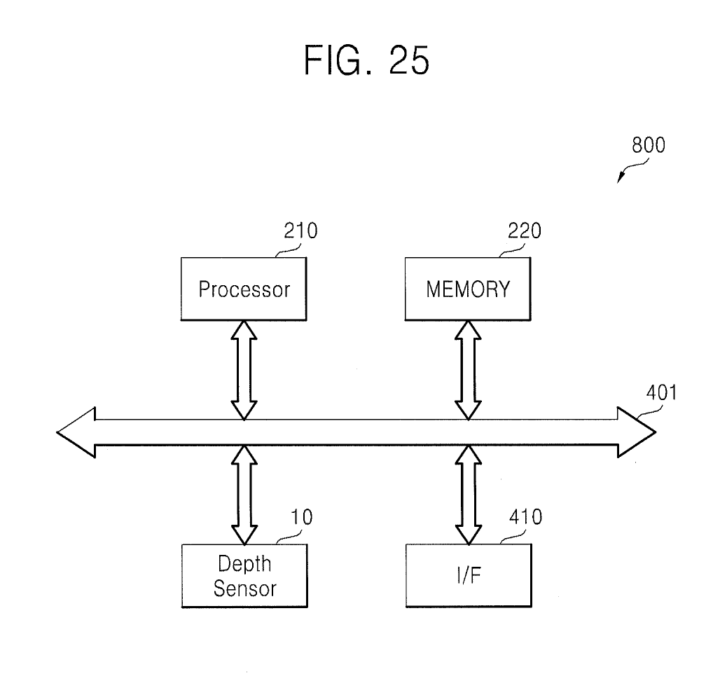

FIG. 25 is a block diagram of a signal processing system 800 including the depth sensor 10 according to an example embodiment. Referring to FIG. 25, the signal processing system 800, which simply functions as a depth (or distance) measuring sensor, includes the depth sensor 10 and the processor 210 controlling the operations of the depth sensor 10.

The processor 210 may calculate distance or depth information between the signal processing system 800 and an object (or a target) based on depth information (e.g., the first differential pixel signal A31 and the second differential pixel signal A20) output from the depth sensor 10. The distance or depth information calculated by the processor 210 may be stored in the memory device 220 through a bus 401.

As described above, according to some embodiments, a depth sensor reduces pixel noise and preserves the features of a depth image.

While the embodiments have been particularly shown and described, it will be understood by those of ordinary skill in the art that various changes in forms and details may be made therein without departing from the spirit and scope of the inventive concepts as defined by the following claims.

What is claimed is:

1. A method of reducing noise in a depth sensor, the method comprising:
calculating similarities between a plurality of pixel signals of a depth pixel and a plurality of pixel signals of neighbor depth pixels neighboring the depth pixel;
calculating a weight of each of the neighbor depth pixels using the similarities;
calculating a weight of the depth pixel using the weights of the respective neighbor depth pixels; and
determining a denoised pixel signal using the weights of the respective neighbor depth pixels and the weight of the depth pixel.

2. The method of claim 1, wherein the similarities include:
a first similarity between a first depth differential pixel signal of the depth pixel and a first neighbor differential pixel signal of each of the neighbor depth pixels, the first depth differential pixel signal of the depth pixel being a difference between a first pair of the plurality of pixel signals of the depth pixel, the first neighbor differential pixel signal of each of the neighbor depth pixels being a difference between a first pair of the plurality of pixel signals of the neighbor depth pixels;
a second similarity between a second depth differential pixel signal of the depth pixel and a second neighbor differential pixel signal of each of the neighbor depth pixels, the second depth differential pixel signal of the depth pixel being a difference between a second pair of the plurality of pixel signals of the depth pixel, the second neighbor differential pixel signal of each of the neighbor depth pixels being a difference between a second pair of the plurality of pixel signals of the neighbor depth pixels;
a third similarity between an amplitude of the depth pixel and an amplitude of each of the neighbor depth pixels; and
a fourth similarity between an offset of the depth pixel and an offset of each of the neighbor depth pixels, the offset of the depth pixel being based on the difference between the first pair and the difference between the second pair of the plurality of pixel signals of the depth pixel, the offset of each of the neighbor depth pixels being based on the difference between the first pair and the difference between the second pair of the neighbor depth pixels.

3. The method of claim 2, wherein the plurality of pixel signals of the depth pixel and each of the neighboring pixels respectively includes first, second, third and fourth pixel signals, the method further comprising:
calculating each of the first differential pixel signals by subtracting the second pixel signal from the fourth pixel signal respectively associated with the depth pixel and the neighbor depth pixels;
calculating each of the second differential pixel signals by subtracting the first pixel signal from the third pixel signal respectively associated with the depth pixel and the neighbor depth pixels;
calculating amplitudes of the depth pixel and the neighbor depth pixels based on the first through fourth pixel signals associated therewith.

4. The method of claim 2, wherein the calculating the weight of each of the neighbor depth pixels comprises adding a product of the first similarity and a first weight coefficient, a product of the second similarity and a second weight coefficient, a product of the third similarity and a third weight coefficient, and a product of the fourth similarity and a fourth weight coefficient together.

5. The method of claim 2, wherein the calculating the weight of each of the neighbor depth pixels comprises multiplying the first similarity to a power of a first weight coefficient of the first similarity, the second similarity to a power of a second weight coefficient of the second similarity, the third similarity to a power of a third weight coefficient of the third similarity, and the fourth similarity to a power of a fourth weight coefficient of the fourth similarity together.

6. The method of claim 5, wherein a sum of the first through fourth weight coefficients is 1.

7. The method of claim 1, wherein the calculating the weight of the depth pixel comprises subtracting weights of the respective neighbor depth pixels from a value obtained by adding one plus a number of the neighbor depth pixels.

8. The method of claim 2, wherein the calculating the denoised pixel signal comprises dividing a first value by a second value, the first value obtained by adding a product of the first differential pixel signal of the depth pixel and the weight of the depth pixel to a sum of values obtained by respectively multiplying the first differential pixel signals of the respective neighbor depth pixels by the weights of the respective neighbor depth pixels, the second value obtained by adding one plus a number of the neighbor depth pixels.

9. The method of claim 2, wherein the calculating the denoised pixel signal comprises dividing a first value by a second value, the first value obtained by adding a product of the second differential pixel signal of the depth pixel and the weight of the depth pixel to a sum of values obtained by respectively multiplying the second differential pixel signals of the respective neighbor depth pixels by the weights of the respective neighbor depth pixels, the second value obtained by adding one plus a number of the neighbor depth pixels.

10. The method of claim 1, wherein the denoised pixel signal is one of a denoised first differential pixel signal and a denoised second differential pixel signal.

11. The method of claim 10, further comprising:
generating one of an updated first differential pixel signal and an updated second differential pixel signal based on the denoised pixel signal.

12. The method of claim 11, wherein the generating one of the updated first and second differential pixel signals is repeated.

13. A depth sensor comprising:
a light source configured to emit modulated light to a target object;
a depth pixel and neighbor depth pixels neighboring the depth pixel, each of the depth pixel and the neighbor depth pixels configured to detect a plurality of pixel signals at different time points according to light reflected from the target object;
a digital circuit configured to convert the plurality of pixel signals into a plurality of digital pixel signals;
a memory configured to store the plurality of digital pixel signals; and
a noise reduction filter configured to calculate similarities between a plurality of digital pixel signals of the depth pixel and a plurality of digital pixel signals of each of the neighbor depth pixels, calculate a weight of each of the neighbor depth pixels using the similarities, calculate a weight of the depth pixel using the weights of the respective neighbor depth pixels, and determine a denoised pixel signal using the weights of the respective neighbor depth pixels and the weight of the depth pixel.

14. The depth sensor of claim 13, wherein the similarities comprise:
a first similarity between a first depth differential digital pixel signal of the depth pixel and a first neighbor differential digital pixel signal of each of the neighbor depth pixels, the first differential pixel signal of the depth pixel being a difference between a first pair of the plurality of pixel signals of the pixel, the first neighbor differential pixel signal of each of the neighbor depth pixels being a difference between a first pair of the plurality of pixel signals of the neighbor depth pixels;
a second similarity between a second depth differential digital pixel signal of the depth pixel and a second neighbor differential digital pixel signal of each of the neighbor depth pixels, the second depth differential pixel signal of the depth pixel being a difference between a second pair of the plurality of pixel signals of the depth pixel, the second neighbor differential pixel signal of each of the neighbor depth pixels being a difference between a second pair of the plurality of pixel signals of the neighbor depth pixels;
a third similarity between an amplitude of the depth pixel and an amplitude of each of the neighbor depth pixels; and
a fourth similarity between an offset of the depth pixel and an offset of each of the neighbor depth pixels, the offset of the depth pixel being based on the difference between the first pair and the difference between the second pair of the plurality of pixel signals of the depth pixel, the offset of each of the neighbor depth pixels being based on the difference between the first pair and the difference between the second pair of the neighbor depth pixels.

15. The depth sensor of claim 13, wherein the noise reduction filter is configured to calculate the weight of the depth pixel by subtracting weights of the respective neighbor depth pixels from a value obtained by adding one plus the number of the neighbor depth pixels.

16. A method of reducing noise in a depth sensor, the method of comprising:
determining at least one similarity metric between output from a depth pixel and at least one neighbor depth pixel, the neighbor depth pixel neighboring the depth pixel;
determining a weight associated with the neighbor depth pixel based on the similarity metric; and
filtering output from the depth pixel based on the determined weight.

17. The method of claim 16, wherein
determining the neighbor depth pixel based on a filter mask applied to the depth pixel.

18. The method of claim 16, wherein the output from the depth pixel is output from a 2-tap pixel.

19. The method of claim 16, wherein
the determining the similarity metric determines the similarity metric based on a first difference between output from the depth pixel and a second difference between output of the neighbor depth pixel.

20. The method of claim 16, further comprising:
determining a weight associated with the depth pixel based on the weight associated with the neighbor depth pixel; and wherein
the filtering filters output from the depth pixel based on the weight associated with the depth pixel and the weight associated with the neighbor depth pixel.
